(19) United States
(12) Patent Application Publication
(10) Pub. No.: US 2012/0253960 A1
(43) Pub. Date: Oct. 4, 2012

(54) METHODS, SOFTWARE ARRANGEMENTS, STORAGE MEDIA, AND SYSTEMS FOR PROVIDING A SHRINKAGE-BASED SIMILARITY METRIC

(75) Inventors: Vera Cherepinsky, Sandy Hook, CT (US); Jia-Wu Feng, Beijing (CN); Marc Rejali, New London (GB); Bhubaneswar Mishra, Great Neck, NY (US)

(73) Assignee: New York University, New York, NY (US)

(21) Appl. No.: 13/323,425

(22) Filed: Dec. 12, 2011

Related U.S. Application Data
(62) Division of application No. 10/554,669, filed on Oct. 24, 2005, now abandoned.

(51) Int. Cl. G06F 19/22; G06Q 30/00; G06Q 40/04

(52) U.S. Cl. 705/26.1; 702/19; 705/37

(57) ABSTRACT

The present invention relates to systems, methods, and software arrangements for determining associations between two or more datasets. The systems, methods, and software arrangements used to determine such associations include a determination of a correlation coefficient that incorporates both prior assumptions regarding such datasets and actual information regarding the datasets. The systems, methods, and software arrangements of the present invention can be useful in an analysis of microarray data, including gene expression arrays, to determine correlations between genotypes and phenotypes. Accordingly, the systems, methods, and software arrangements of the present invention may be utilized to determine a genetic basis of complex genetic disorder (e.g. those characterized by the involvement of more than one gene).

### CROSS REFERENCE TO RELATED APPLICATION

This application claims priority from U.S. Patent Application Ser. No. 60/464,983 filed on Apr. 24, 2003, the entire disclosure of which is incorporated herein by reference.

### FIELD OF THE INVENTION

The present invention relates generally to systems, methods, and software arrangements for determining associations between one or more elements contained within two or more datasets. For example, the embodiments of systems, methods, and software arrangements determining such associations may obtain a correlation coefficient that incorporates both prior assumptions regarding two or more datasets and actual information regarding such datasets.

### BACKGROUND OF THE INVENTION

Recent improvements in observational and experimental techniques allow those of ordinary skill in the art to better understand the structure of a substantially unobservable transparent cell. For example, microarray-based gene expression analysis may allow those of ordinary skill in the art to quantify the transcriptional states of cells. Partitioning or clustering genes into closely related groups has become an important mathematical process in the statistical analyses of microarray data.

Traditionally, algorithms for cluster analysis of genome-wide expression data from DNA microarray hybridization were based upon statistical properties of gene expressions, and result in organizing genes according to similarity in pattern of gene expression. These algorithms display the output graphically, often in a binary tree form, conveying the clustering and the underlying expression data simultaneously. If two genes belong to the same cluster (or, equivalently, if they belong to the same subtree of small depth), then it may be possible to infer a common regulatory mechanism for the two genes, or to interpret this information as an indication of the status of cellular processes. Furthermore, a coexpression of genes of known function with novel genes may result in a discovery process for characterizing unknown or poorly characterized genes. In general, false negatives (where two coexpressed genes are assigned to distinct clusters) may cause the discovery process to ignore useful information for certain novel genes, and false positives (where two independent genes are assigned to the same cluster) may result in noise in the information provided to the subsequent algorithms used in analyzing regulatory patterns. Consequently, it may be important that the statistical algorithms for clustering are reasonably robust. Nevertheless, the microarray experiments that can be carried out in an academic laboratory at a reasonable cost are minimal, and suffer from an experimental noise. As such, those of ordinary skill in the are may use certain algorithms to deal with small, sample data.

One conventional clustering algorithm is described in Eisen et al. (“Eisen”), Proc. Natl. Acad. Sci. USA 95, 14863-14868 (1998). In Eisen, the gene-expression data were collected on spotted DNA microarrays (See, e.g., Schena et al. (“Schena”), Proc. Natl. Acad. Sci. USA 93, 10614-10619 (1996)), and were based upon gene expression in the budding yeast Saccharomyces cerevisiae during the diauxic shift (See, e.g., DeRisi et al. (“DeRisi”), Science 278, 680-686 (1997)), the mitotic cell division cycle (See, e.g., Spellman et al. (“Spellman”), Mol. Biol. Cell 9, 3273-3297 (1998)), sporulation (See, e.g., Chu et al. (“Chu”), Science 282, 699-705 (1998)), and temperature and reducing shocks. The disclosures of each of these references are incorporated herein by reference in their entireties. In Eisen, RNA from experimental samples (taken at selected times during the process) were labeled during reverse transcription with a red-fluorescent dye Cy5, and mixed with a reference sample labeled in parallel with a green-fluorescent dye Cy3. After hybridization and appropriate washing steps, separate images were acquired for each fluorophor, and fluorescence intensity ratios obtained for all target elements. The experimental data were provided in an M×N matrix structure, in which the M rows represented all genes for which data had been collected, the N columns represented individual array experiments (e.g., single time points or conditions), and each entry represented the measured Cy5/Cy3 fluorescence ratio at the corresponding target element on the appropriate array. All ratio values were log-transformed to treat inductions and repressions of identical magnitude as numerically equal but opposite in sign. In Eisen, it was assumed that the raw ratio values followed log-normal distributions and hence, the log-transformed data followed normal distributions.

The gene similarity metric employed in this publication was a form of a correlation coefficient. Let Gᵢ be the (log-transformed) primary data for a gene G in condition i. For any two genes X and Y observed over a series of N conditions, the classical similarity score based upon a Pearson correlation coefficient is:

$$S ( X , Y ) = \frac{1}{N} {\sum }_{i = 1}^{N} ( \frac{{X}_{i} - {X}_{offset}}{{Φ}_{X}} ) ( \frac{{Y}_{i} - {Y}_{offset}}{{Φ}_{Y}} ) , \\ where$$

$${Φ}_{G}^{2} = {\sum }_{i = 1}^{N} \frac{{( {G}_{i} - {G}_{offset} )}^{2}}{N}$$

and G_{offset} is the estimated mean of the observations,

$${G}_{offset} = \overline{G} = \frac{1}{N} {\sum }_{i = 1}^{N} {G}_{i} .$$

Φ_{G} is the (resealed) estimated standard deviation of the observations. In the Pearson correlation coefficient model, G_{offset} is set equal to 0. Nevertheless, in the analysis described in Eisen, “values of G_{offset} which are not the average over observations on G were used when there was an assumed unchanged or reference state represented by the value of G_{offset}, against which changes were to be analyzed; in all of the examples presented there, G_{offset} was set to 0, corresponding to a fluorescence ratio of 1.0.” To distinguish this modified correlation coefficient from the classical Pearson correlation coefficient, we shall refer to it as Eisen correlation coefficient. Nevertheless, setting G_{offset} equal to 0 or 1 results in an increase in false positives or false negatives, respectively.

### SUMMARY OF THE INVENTION

The present invention relates generally to systems, methods, and software arrangements for determining associations between one or more elements contained within two or more datasets. An exemplary embodiment of the systems, methods, and software arrangements determining the associations may obtain a correlation coefficient that incorporates both prior assumptions regarding two or more datasets and actual information regarding such datasets. For example, an exemplary embodiment of the present invention is directed toward systems, methods, and software arrangements in which one of the prior assumptions used to calculate the correlation coefficient is that an expression vector mean μ of each of the two or more datasets is a zero-mean normal random variable (with an a priori distribution N(0,τ²)), and in which one of the actual pieces of information is an a posteriori distribution of expression vector mean μ that can be obtained directly from the data contained in the two or more datasets. The exemplary embodiment of the systems, methods, and software arrangements of the present invention are more beneficial in comparison to conventional methods in that they likely produce fewer false negative and/or false positive results. The exemplary embodiment of the systems, methods, and software arrangements of the present invention are further useful in the analysis of microarray data (including gene expression arrays) to determine correlations between genotypes and phenotypes. Thus, the exemplary embodiments of the systems, methods, and software arrangements of the present invention are useful in elucidating the genetic basis of complex genetic disorders (e.g., those characterized by the involvement of more than one gene).

According to the exemplary embodiment of the present invention, a similarity metric for determining an association between two or more datasets may take the form of a correlation coefficient. However, unlike conventional correlations, the correlation coefficient according to the exemplary embodiment of the present invention may be derived from both prior assumptions regarding the datasets (including but not limited to the assumption that each dataset has a zero mean), and actual information regarding the datasets (including but not limited to an a posteriori distribution of the mean). Thus, in one the exemplary embodiment of the present invention, a correlation coefficient may be provided, the mathematical derivation of which can be based on James-Stein shrinkage estimators. In this manner, it can be ascertained how a shrinkage parameter of this correlation coefficient may be optimized from a Bayesian point of view, e.g., by moving from a value obtained from a given dataset toward a “believed” or theoretical value. For example, in one exemplary embodiment of the present invention, G_{offset} of the gene similarity metric described above may be set equal to γ G̅, where γ is a value between 0.0 and 1.0. When γ=1.0, the resulting similarity metric may be the same as the Pearson correlation coefficient, and when γ=0.0, it may be the same as the Eisen correlation coefficient. However, for a non-integer value of γ (i.e., a value other than 0.0 or 1.0), the estimator for G_{offset}=γ G̅ can be considered as the unbiased estimator G decreasing toward the believed value for G_{offset}. This optimization of the correlation coefficient can minimize the occurrence of false positives relative to the Eisen correlation coefficient, and the occurrence of false negatives relative to the Pearson correlation coefficient.

According to an exemplary embodiment of the present invention, the general form of the following equation:

$$\begin{matrix}S ( X , Y ) = \frac{1}{N} {\sum }_{i = 1}^{N} ( \frac{{X}_{i} - {X}_{offset}}{{Φ}_{X}} ) ( \frac{{Y}_{i} - {Y}_{offset}}{{Φ}_{Y}} ) , \\ where & ( 1 ) \\ {Φ}_{G} = \sqrt{\frac{1}{N} {\sum }_{i = 1}^{N} {( {G}_{i} - {G}_{offset} )}^{2}} \\ and \\ {G}_{offset} = γ \overline{G} for G ∈ \{ X , Y \} & ( 2 )\end{matrix}$$

can be used to derive a similarity metric which is dictated by the data. In a general setting, all values Xᵢⱼ for gene j may have a Normal distribution with mean θⱼ and standard deviation βⱼ (variance βⱼ²); i.e., Xᵢⱼ˜N(θⱼ,βⱼ²) for i=1, . . . , N, with j fixed (1≦j≦M), where θⱼ is an unknown parameter (taking different values for different j). For the purpose of estimation, θⱼ can be assumed to be a random variable taking values close to zero: θⱼ˜N(0, τ²).

In one exemplary embodiment of the present invention, the posterior distribution of θⱼ may be derived from the prior N(0, τ²) and the data via the application of James-Stein Shrinkage estimators. θⱼ then may be estimated by its mean. In another exemplary embodiment, the James-Stein Shrinkage estimators are W and \hat{β}².

In yet another exemplary embodiment of the present invention, the posterior distribution of θⱼ may be derived from the prior N(0, τ²) and the data from the Bayesian considerations. θⱼ then may be estimated by its mean.

The present invention further provides exemplary embodiments of the systems, methods, and software arrangements for implementation of hierarchical clustering of two or more datapoints in a dataset. In one preferred embodiment of the present invention, the datapoints to be clustered can be gene expression levels obtained from one or more experiments, in which gene expression levels may be analyzed under two or more conditions. Such data documenting alterations in the gene expression under various conditions may be obtained by microarray-based genomic analysis or other high-throughput methods known to those of ordinary skill in the art. Such data may reflect the changes in gene expression that occur in response to alterations in various phenotypic indicia, which may include but are not limited to developmental and/or pathophysiological (i.e., disease-related) changes. Thus, in one exemplary embodiment of the present invention, the establishment of genotype/phenotype correlations may be permitted. The exemplary systems, methods, and software arrangements of the present invention may also obtain genotype/phenotype correlations in complex genetic disorders, i.e., those in which more than one gene may play a significant role. Such disorders include, but are not limited to, cancer, neurological diseases, developmental disorders, neurodevelopmental disorders, cardiovascular diseases, metabolic diseases, immunologic disorders, infectious diseases, and endocrine disorders.

According to still another exemplary embodiment of the present invention, a hierarchical clustering pseudocode may be used in which a clustering procedure is utilized by selecting the most similar pair of elements, starting with genes at the bottom-most level, and combining them to create a new element. In one exemplary embodiment of the present invention, the “expression vector” for the new element can be the weighted average exemplary of the expression vectors of the two most similar elements that were combined. In another embodiment of the present invention, the structure of repeated pair-wise combinations may be represented in a binary tree, whose leaves can be the set of genes, and whose internal nodes can be the elements constructed from the two children nodes.

In another preferred embodiment of the present invention, the datapoints to be clustered may be values of stocks from one or more stock markets obtained at one or more time periods. Thus, in this preferred embodiment, the identification of stocks or groups of stocks that behave in a coordinated fashion relative to other groups of stocks or to the market as a whole can be ascertained. The exemplary embodiment of the systems, methods, and software arrangements of the present invention therefore may be used for financial investment and related activities.

For a better understanding of the present invention, together with other and further objects, reference is made to the following description, taken in conjunction with the accompanying drawings, and its scope will be pointed out in the appended claims.

### BRIEF DESCRIPTION OF THE DRAWINGS

For a more complete understanding of the present invention and its advantages, reference is now made to the following description, taken in conjunction with the accompanying drawings, in which:

FIG. 1 is a first exemplary embodiment of a system according to the present invention for determining an association between two datasets based on a combination of data regarding one or more prior assumptions about the datasets and actual information derived from such datasets;

FIG. 2 is a second exemplary embodiment of the system according to the present invention for determining the association between the datasets;

FIG. 3 is an exemplary embodiment of a process according to the present invention for determining the association between two datasets which can utilize the exemplary systems of FIGS. 1 and 2;

FIG. 4 is an exemplary illustration of histograms generated by performing in silico experiments with the four different algorithms, under four different conditions;

FIG. 5 is a schematic diagram illustrating the regulation of cell-cycle functions of yeast by various, translational activators (Simon et al., Cell 106: 67-708 (2001)), used as a reference to test the performance of the present invention;

FIG. 6 depicts Receiver Operator Characteristic (ROC) curves for each of the three algorithms Pearson, Eisen or Shrinkage, in which each curve is parameterized by the cut-off value θε{1.0, 0.95, . . . , −1.0};

FIGS. 7A-B show FN (Panel A) and FP (Panel B) curves, each plotted as a function of θ; and

FIG. 8 shows ROC curves, with threshold plotted on the z-axis.

### DETAILED DESCRIPTION OF THE INVENTION

An exemplary embodiment of the present invention provides systems, methods, and software arrangements for determining one or more associations between one or more elements contained within two or more datasets. The determination of such associations may be useful, inter alia, in ascertaining coordinated changes in a gene expression that may occur, for example, in response to alterations in various phenotypic indicia, which may include (but are not limited to) developmental and/or pathophysiological (i.e., disease-related) changes establishment of these genotype/phenotype correlations can permit a better understanding of a direct or indirect role that the identified genes may play in the development of these phenotypes. The exemplary systems, methods, and software arrangements of the present invention can further be useful in elucidating genotype/phenotype correlations in complex genetic disorders, i.e., those in which more than one gene may play a significant role. The knowledge concerning these relationships may also assist in facilitating the diagnosis, treatment and prognosis of individuals bearing a given phenotype. The exemplary systems, methods, and software arrangements of the present invention also may be useful for financial planning and investment.

FIG. 1 illustrates a first exemplary embodiment of a system for determining one or more associations between one or more elements contained within two or more datasets. In this exemplary embodiment, the system includes a processing device 10 which is connected to a communications network 100 (e.g., the Internet) so that it can receive data regarding prior assumptions about the datasets and/or actual information determined from the datasets. The processing device 10 can be a mini-computer (e.g., Hewlett Packard mini computer), a personal computer (e.g., a Pentium chip-based computer), a mainframe computer (e.g., IBM 3090 system), and the like. The data can be provided from a number of sources. For example, this data can be prior assumption data 110 obtained from theoretical considerations or actual data 120 derived from the dataset. After the processing device 10 receives the prior assumption data 110 and the actual information 120 derived from the dataset via the communications network 100, it can then generate one or more results 20 which can include an association between one or more elements contained in one or more datasets.

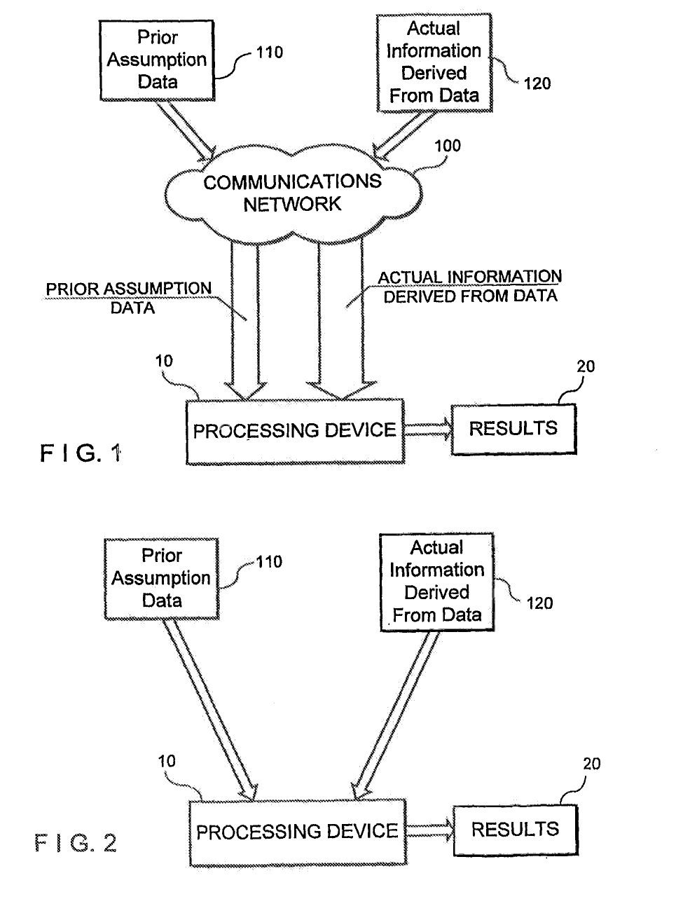

FIG. 2 illustrates a second exemplary embodiment of the system 10 according to the present invention in which the prior assumption data 110 obtained from theoretical considerations or actual data 120 derived from the dataset is transmitted to the system 10 directly from an external source, e.g., without the use of the communications network 100 for such transfer of the data. In this second exemplary embodiment of the system 10, it is also possible for the prior assumption data 110 obtained from theoretical considerations or the actual information 120 derived from the dataset to be obtained from a storage device provided in or connected to the processing device 10. Such storage device can be a hard drive, a CD-ROM, etc. which are known to those having ordinary skill in the art.

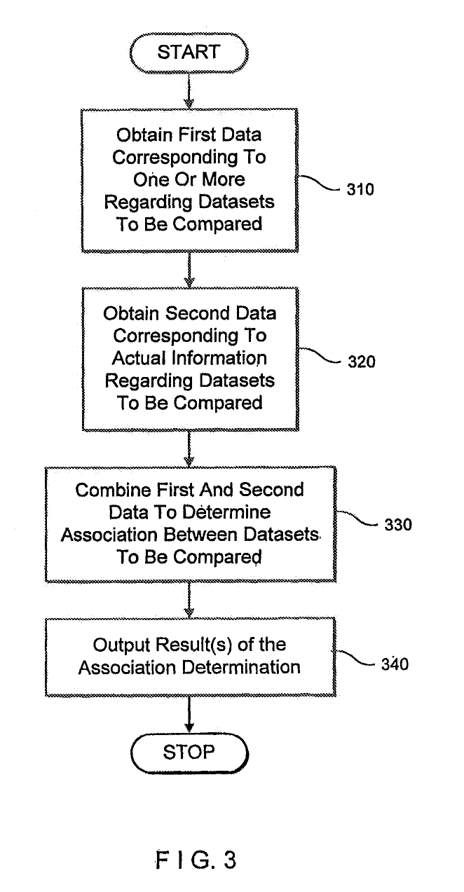

FIG. 3 shows an exemplary flow chart of the embodiment of the process according to the present invention for determining an association between two datasets based on a combination of data regarding one or more prior assumptions about and actual information derived from the datasets. This process can be performed by the exemplary processing device 10 which is shown in FIG. 1 or 2.

As shown in FIG. 3, the processing device 10 receives the prior assumption data 110 (first data) obtained from theoretical considerations in step 310. In step 320, the processing device 10 receives actual information 120 derived from the dataset (second data). In step 330, the prior assumption (first) data obtained 110 from theoretical considerations and the actual (second) data 120 derived from the dataset are combined to determine an association between two or more datasets. The results of the association determination are generated in step 340.

### I. OVERALL PROCESS DESCRIPTION

The exemplary systems, methods, and software arrangements according to the present invention may be (e.g., as shown in FIGS. 1-3) used to determine the associations between two or more elements contained in datasets to obtain a correlation coefficient that incorporates both prior assumptions regarding the two or more datasets and actual information regarding such datasets. One exemplary embodiment of the present invention provides a correlation coefficient that can be obtained based on James-Stein Shrinkage estimators, and teaches how a shrinkage parameter of this correlation coefficient may be optimized from a Bayesian point of view, moving from a value obtained from a given dataset toward a “believed” or theoretical value. Thus, in one exemplary embodiment of the present invention, G_{offset} may be set equal to γ G̅, where γ is a value between 0.0 and 1.0. When γ=1.0, the resulting similarity metric γ may be the same as the Pearson correlation coefficient, and when γ=0.0, γ may be the same as the Eisen correlation coefficient. For a non-integer value of γ (i.e., a value other than 0.0 or 1.0), the estimator for G_{offset}=γ G̅ can be considered as an unbiased estimator G̅ decreasing toward the believed value for G_{offset}. Such exemplary optimization of the correlation coefficient may minimize the occurrence of false positives relative to the Eisen correlation coefficient and minimize the occurrence of false negatives relative to the Pearson correlation coefficient.

### II. EXEMPLARY MODEL

A family of correlation coefficients parameterized by 0≦γ≦1 may be defined as follows:

$$\begin{matrix}S ( X , Y ) = \frac{1}{N} {\sum }_{i = 1}^{N} ( \frac{{X}_{i} - {X}_{offset}}{{Φ}_{X}} ) ( \frac{{Y}_{i} - {Y}_{offset}}{{Φ}_{Y}} ) , \\ where & ( 1 ) \\ {Φ}_{G} = \sqrt{\frac{1}{N} {\sum }_{i = 1}^{N} {( {G}_{i} - {G}_{offset} )}^{2}} and \\ {G}_{offset} = γ \overline{G} for G ∈ \{ X , Y \} & ( 2 )\end{matrix}$$

In contrast, the Pearson Correlation Coefficient uses

$${G}_{offset} = \overline{G} = \frac{1}{N} {\sum }_{j = 1}^{N} {G}_{i}$$

for every gene G, or γ=1, and the Eisen Correlation Coefficient uses G_{offset}=0 for every gene G, or γ=0.

In an exemplary embodiment of the present invention, the general form of equation (1) may be used to derive a similarity metric which is dictated by both the data and prior assumptions regarding the data, and that reduces the occurrence of false positives (relative to the Eisen metric) and false negatives (relative to the Pearson correlation coefficient).

### Setup

As described above, the metric used by Eisen had the form of equation (1) with G_{offset} set to 0 for every gene G (as a reference state against which to measure the data). Nevertheless, even if it is initially assumed that each gene G has zero mean, such assumption should be updated when data becomes available. In an exemplary embodiment of the present invention, gene expression data may be provided in the form of the levels of M genes expressed under N experimental conditions. The data can be viewed as

{{Xᵢⱼ}ᵢ₌₁^{N}}ⱼ₌₁^{M}

where M>>N and {Xᵢⱼ}ᵢ₌₁^{N} is the data vector for gene j.

### Derivation

S may be rewritten in the following notation:

$$S ( {X}_{j} , {X}_{k} ) = \frac{1}{N} {\sum }_{i = 1}^{N} ( \frac{{X}_{ij} - {( {X}_{j} )}_{offset}}{{Φ}_{j}} ) ( \frac{{X}_{ik} - {( {X}_{k} )}_{offset}}{{Φ}_{k}} ) , \\ {Φ}_{j}^{2} = \frac{1}{N} {\sum }_{i} {( {X}_{ij} - {( {X}_{j} )}_{offset} )}^{2} \qquad ( 3 )$$

In a general setting, the following exemplary assumptions may be made regarding the data distribution: let all values Xᵢⱼ for gene j have a Normal distribution with mean θⱼ and standard deviation βⱼ (variance βⱼ²); i.e., Xᵢⱼ˜N(θⱼ,βⱼ²) for i=1, . . . , N, with j fixed (1≦j≦M), where θⱼ is an unknown parameter (taking different values for different j). For the purpose of estimation, θⱼ can be assumed to be a random variable taking values close to zero: θⱼ˜N(0, τ²).

It is also possible according to the present invention to assume that the data are range-normalized, such that βⱼ²=β² for every j. If this exemplary assumption does not hold true on a given data set, it can be corrected by scaling each gene vector appropriately. Using conventional methods, the range may be adjusted to scale to an interval of unit length, i.e., its maximum and minimum values differ by 1. Thus, Xᵢⱼ˜N(θⱼ,βⱼ²) and θⱼ˜N(θ, _{T}²).

Replacing (Xⱼ)_{offset} in equation (3) by the exact value of the mean θⱼ may yield a Clairvoyant correlation coefficient of Xⱼ and Xₖ. Nevertheless, because θⱼ is a random variable, it should be estimated from the data. Therefore, to obtain an explicit formula for S(Xⱼ,Xₖ), it is possible to derive estimators \hat{θ}ⱼ for all j.

In Pearson correlation coefficient, θⱼ may be estimated by the vector mean X̅.ⱼ; and the Eisen correlation coefficient corresponds to replacing θⱼ by 0 for every j, which is equivalent to assuming θⱼ ˜N(0,0) (i.e., τ²=0). In an exemplary embodiment of the system, method, and software arrangement according to the present invention, an estimate of θⱼ (call it) may be determined that takes into \hat{θ}ⱼ account both the prior assumption and the data.

### Estimation of θⱼ

a. N=1

First, it is possible according to the present invention to obtain the posterior distribution of θⱼ from the prior N(0,τ²) and the data. This exemplary derivation can be done either from the Bayesian considerations, or via the James-Stein Shrinkage estimators (See, e.g., James et al. (“James”), Proc. 4th Berkeley Symp. Math. Statist. Vol. 1, 361-379 (1961); and Hoffman, Statistical Papers 41(2), 127-158 (2000), the disclosures of which are incorporated herein by reference in their entireties). In this exemplary embodiment of the present invention, the Bayesian estimators method can be applied, and it may initially be assumed that N=1, i.e., there is one data point for each gene. Moreover, the variance can initially be denoted by σ², such that:

Xⱼ˜N(θⱼ,σ²) (4)

θⱼ˜N(θ0,_{T}²) (5)

For the sake of clarity, the probability density function (pdf) of θⱼ can be denoted by τ(•), and the pdf of Xⱼ can be denoted by f(•). Based on equations (4) and (5), the following relationships may be derived:

$$π ( {θ}_{j} ) = \frac{1}{\sqrt{2 π} τ} exp ( {θ}_{j}^{2} / 2 {τ}^{2} ) , \\ f ( {X}_{j} \vert {θ}_{j} ) = \frac{1}{\sqrt{2 π} σ} exp ( - {( {X}_{j} - {θ}_{j} )}^{2} / 2 {σ}^{2} ) .$$

By Bayes' Rule, the joint pdf of Xⱼ and θⱼ may be given by

$$\begin{matrix}f ( {X}_{j} , {θ}_{j} ) = f ( {X}_{j} \vert {θ}_{j} ) π ( {θ}_{j} ) \\ = \frac{1}{2 πστ} exp ( - [ \frac{{θ}_{j}^{2}}{2 {τ}^{2}} + \frac{{( {X}_{j} - {θ}_{j} )}^{2}}{2 {σ}^{2}} ] )\end{matrix} \qquad ( 6 )$$

Then f(Xⱼ), the marginal pdf of Xⱼ may be

$$\begin{matrix}f ( {X}_{j} ) = {E}_{θ j} f ( {X}_{j} \vert {θ}_{j} ) \\ = {\int }_{θ = - ∞}^{∞} f ( {X}_{j} \vert θ ) π ( θ ) d θ \\ = \frac{1}{\sqrt{2 π ( {σ}^{2} + {τ}^{2} )}} exp ( - \frac{{X}_{j}^{2}}{2 ( {σ}^{2} + {τ}^{2} )} ) ,\end{matrix} \qquad ( 7 )$$

where the equality in equation (7) is written out in Appendix A.2. Based again on Bayes' Theorem, the posterior distribution of θⱼ may be given by:

$$\begin{matrix}π ( {θ}_{j} \vert {X}_{j} ) = \frac{f ( {X}_{j} , {θ}_{j} )}{f ( {X}_{j} )} \\ = \frac{f ( {X}_{j} \vert {θ}_{j} ) π ( {θ}_{j} )}{f ( {X}_{j} )} by ( 6 ) \\ = \frac{1}{\sqrt{2 π \frac{{σ}^{2} {τ}^{2}}{{σ}^{2} + {τ}^{2}}}} exp [ - \frac{{( {θ}_{j} - \frac{{τ}^{2}}{{σ}^{2} + {τ}^{2}} {X}_{j} )}^{2}}{2 ( \frac{{σ}^{2} {τ}^{2}}{{σ}^{2} + {τ}^{2}} )} ] .\end{matrix} \qquad ( 8 )$$

(See Appendix A.3 for derivation of equation (8).)

Since this has a Normal form, it can be determined that:

$$\begin{matrix}E ( {θ}_{j} \vert {X}_{j} ) = \frac{{τ}^{2}}{{σ}^{2} + {τ}^{2}} {X}_{j} \\ = ( 1 - \frac{{σ}^{2}}{{σ}^{2} + {τ}^{2}} ) {X}_{j} ,\end{matrix} \\ Var ( {θ}_{j} \vert {X}_{j} ) = \frac{{σ}^{2} {τ}^{2}}{{σ}^{2} + {τ}^{2}} . \qquad ( 9 )$$

θⱼ then may be estimated by its mean.

b. N is Arbitrary

In contrast to above where N was selected to be 1, if N is selected to be arbitrary and greater than 1, Xⱼ becomes a vector X.ⱼ. It can be shown using likelihood functions that the vector of values {Xᵢⱼ}ᵢ₌₁^{N}, with Xᵢⱼ˜N(θⱼ, β²) may be treated as a single data point

$${Y}_{j} = {\overline{X}}_{\cdot j} = \sum \frac{N}{i - 1} {X}_{ij} / N$$

from the distribution N(θⱼ, β²/N) (see Appendix A.4). Thus, following the above derivation with σ²=β²/N, a Bayesian estimator for θⱼ may be given by E(θⱼ|X.ⱼ):

$$= ( 1 - \frac{{β}^{2} / N}{{β}^{2} / N + {τ}^{2}} ) {Y}_{j} . \qquad ( 10 )$$

However, equation (10) may likely not be directly used in equation (3) because τ² and β² may be unknown, such that τ² and β² should be estimated from the data.

c. Estimation of 1/(β²/N+τ²)

In this exemplary embodiment of the present invention, let

$$W = \frac{M - 2}{{\sum }_{j = 1}^{M} {Y}_{j}^{2}} . \qquad ( 11 )$$

This equation for W is obtained from James-Stein estimation. W may be treated as an educated guess of an estimator for 1/(β²/N+τ²), and it can be verified that W is an appropriate estimator for 1/(β²/N+τ²), as follows:

$$\begin{matrix}{Y}_{j} ∼ {θ}_{j} + \frac{{β}^{2}}{N} \\ ∼ {τ}^{2} ( 0 , 1 ) + \frac{{β}^{2}}{N} ( 0 , 1 ) \\ ∼ ( \frac{{β}^{2}}{N} + {τ}^{2} ) ( 0 , 1 ) ∼\end{matrix} \qquad ( 12 )$$

The transition in equation is set forth in Appendix A.5. If we let α²=β²/N+τ², then from equation (12) it follows that:

$$\frac{{Y}_{j}}{\sqrt{{α}^{2}}} = \frac{{Y}_{j}}{α} ∼ ( 0 , 1 ) , \\ and hence$$

$${\sum }_{j = 1}^{M} {Y}_{j}^{2} = {α}^{2} {\sum }_{j = 1}^{M} {( \frac{{Y}_{j}}{α} )}^{2} = {α}^{2} {χ}_{M}^{2} ,$$

where X_{M}² is a Chi-square random variable with M degrees of freedom. By properties of the Chi-square distribution and the linearity of expectation,

$$E ( \frac{{α}^{2}}{\sum {Y}_{j}^{2}} ) = \frac{1}{M - 2} \\ E ( W ) = E ( \frac{M - 2}{\sum {Y}_{j}^{2}} ) = \frac{1}{{α}^{2}} = \frac{1}{\frac{{β}^{2}}{N} + {τ}^{2}} \qquad ( see Appendix A .6 )$$

Thus, W is an unbiased estimator of 1/(β²/N+τ²), and can be used to replace 1/(β²/N+τ²), in equation (10).

d. Estimation of β²

It can be shown (e.g., see Appendix A.7) that:

$${S}_{j}^{2} = \frac{1}{N - 1} {\sum }_{i = 1}^{N} {( {X}_{ij} - {Y}_{j} )}^{2}$$

is an unbiased estimator for β² based on the data from gene j, and that has a Chi-square distribution with (N−1) degrees of freedom. Since this is

$$\frac{N - 1}{{β}^{2}} {S}_{j}^{2}$$

the case for every j, a more accurate estimate for β² is obtained by pooling all available data, i.e., by averaging the estimates for each j:

$$\begin{matrix}= \frac{1}{M} {\sum }_{j = 1}^{M} {S}_{j}^{2} \\ = \frac{1}{M} {\sum }_{j = 1}^{M} ( \frac{1}{N - 1} {\sum }_{i = 1}^{N} {( {X}_{ij} - {Y}_{j} )}^{2} ) \\ = \frac{1}{M ( N - 1 )} {\sum }_{j = 1}^{M} {\sum }_{i = 1}^{N} {( {X}_{ij} - {Y}_{j} )}^{2} .\end{matrix}$$

may be an unbiased estimator for β², because

$$\begin{matrix}E ( ) = E ( \frac{1}{M} {\sum }_{j = 1}^{M} {S}_{j}^{2} ) \\ = \frac{1}{M} {\sum }_{j = 1}^{M} E ( {S}_{j}^{2} ) \\ = \frac{1}{M} {\sum }_{j = 1}^{M} {β}^{2} \\ = {β}^{2} .\end{matrix}$$

Substituting the estimates (11) and (13) into equation (10), an explicit estimate for θⱼ may be obtained:

$$\begin{matrix}\hat{{θ}_{j}} = ( 1 - \frac{\frac{{β}^{2}}{N} + {τ}^{2}}{} \frac{N}{} ) {Y}_{j} \\ = ( 1 - W \cdot \frac{\hat{{β}^{2}}}{N} ) {Y}_{j} \\ = ( 1 - ( \frac{M - 2}{{\sum }_{k = 1}^{M} {Y}_{k}^{2}} ) \cdot \frac{1}{N} \cdot \frac{1}{M ( N - 1 )} {\sum }_{k = 1}^{M} {\sum }_{i = 1}^{N} {( {X}_{ik} - {Y}_{k} )}^{2} ) {Y}_{j} \\ = \underbrace{( 1 - \frac{M - 2}{MN ( N - 1 )} \cdot \frac{{\sum }_{k = 1}^{M} {\sum }_{i = 1}^{N} {( {X}_{ik} - {Y}_{k} )}^{2}}{{\sum }_{k = 1}^{M} {Y}_{k}^{2}} )}_{γ} {Y}_{j} \\ = γ {\overline{X}}_{j}\end{matrix} \qquad ( 14 )$$

Further, θⱼ from equation (14) may be substituted into the correlation coefficient in equation (3) wherever (Xⱼ)_{offset} appears to obtain an explicit formula for S(X.ⱼ, X.ₖ).

### Clustering

In an exemplary embodiment of the present invention, the genes may be clustered using the same hierarchical clustering algorithm as used by Eisen, except that G_{offset} is set equal to γ G̅, where γ is a value between 0.0 and 1.0. The hierarchical clustering algorithm used by Eisen is based on the centroid-linkage method, which is referred to as “an average-linkage method” described in Sokal et al. (“Sokal”), Univ. Kans. Sci. Bull. 38, 1409-4438 (1958), the disclosure of which is incorporated herein by reference in its entirety. This method may compute a binary tree (dendrogram) that assembles all the genes at the leaves of the tree, with each internal node representing possible clusters at different levels. For any set of M genes, an upper-triangular similarity matrix may be computed by using a similarity metric of the type described in Eisen, which contains similarity scores for all pairs of genes. A node can be created joining the most similar pair of genes, and a gene expression profile can be computed for the node by averaging observations for the joined genes. The similarity matrix may be updated with such new node replacing the two joined elements, and the process may be repeated (M−1) times until a single element remains. Because each internal node can be labeled by a value representing the similarity between its two children nodes (i.e., the two elements that were combined to create the internal node), a set of clusters may be created by breaking the tree into subtrees (e.g., by eliminating the internal nodes with labels below a certain predetermined threshold value). The clusters created in this manner can be used to compare the effects of choosing differing similarity measures.

### III. ALGORITHM & IMPLEMENTATION

An exemplary implementation of a hierarchical clustering can proceed by selecting the most similar pair of elements (starting with genes at the bottom-most level) and combining them to create a new element. The “expression vector” for the new element can be the weighted average of the expression vectors of the two most similar elements that were combined. This exemplary structure of repeated pair-wise combinations may be represented in a binary tree, whose leaves can be the set of genes, and whose internal nodes can be the elements constructed from the two children nodes. The exemplary algorithm according to the present invention is described below in pseudocode.

### Hierarchical Clustering Pseudocode

```
Given{{Xᵢⱼ}ᵢ₌₁^{N}}ⱼ₌₁^{M}
Switch:
Pearson: γ = 1;
Eisen: γ = 0;
Shrinkage: {
              Compute W = (M − 2) /Σⱼ₌₁^{M} X̅.ⱼ²
              Compute [symbol]   = Σⱼ₌₁^{M}Σᵢ₌₁^{N} (Xᵢⱼ − X̅.ⱼ)²/ (M(N − 1))
              γ = 1 − W · [symbol]   /N
          }
```

While (# clusters >1) do
Compute similarity table:

$$S ( {G}_{j} , {G}_{k} ) = \frac{{\sum }_{i} ( {G}_{ij} - {( {G}_{j} )}_{offset} ) ( {G}_{ik} - {( {G}_{k} )}_{offset} )}{\sqrt{{{\sum }_{i} {( {G}_{ij} - {( {G}_{j} )}_{offset} )}^{2} \cdot {\sum }_{i} {( {G}_{k} )}_{offset} )}^{2}}} , \qquad ( 14 )$$

where (Gⱼ)_{offset}=γ G̅ⱼ.
Find (j*, k*)

S(G_{j*},Gₖ*)≧S(Gⱼ,Gₖ) ∀ clusters j, k
Create new cluster N_{j*k*}
=weighted average of G_{j*} and G_{k*}.
Take out clusters j* and k*.

### IV. MATHEMATICAL SIMULATIONS AND EXAMPLES

### a. In Silico Experiment

To compare the performance of these exemplary algorithms, it is possible to conduct an in silico experiment. In such an experiment, two genes X and Y can be created, and N (about 100) experiments can be simulated, as follows:

Xᵢ=θ_{X}+σ_{X}(αᵢ(X,Y)+ [symbol] (0,1)), and

Yᵢ=θ_{Y}+σ_{Y}(αᵢ(X,Y)+ [symbol] (0,1)),

where αᵢ, chosen from a uniform distribution over a range [L, H] (U(L, H)), can be a “bias term” introducing a correlation (or none if all α's are zero) between X and Y. θₓ˜N(0,τ²) and θ_{y}˜N(0,τ²), are the means of X and Y, respectively. Similarly, σx and σy are the standard deviations for X and Y, respectively.
With this model

$$\begin{matrix}S ( X , Y ) = \frac{1}{N} {\sum }_{i = 1}^{N} \frac{( {X}_{i} - {θ}_{X} )}{{σ}_{X}} \frac{( {Y}_{i} - {θ}_{Y} )}{{σ}_{Y}} \\ \sim \frac{1}{N} {\sum }_{i = 1}^{N} ( {α}_{i} + 𝒩 ( 0 , 1 ) ) ( {α}_{i} + 𝒩 ( 0 , 1 ) ) \\ \sim \frac{1}{N} [ ( {\sum }_{i = 1}^{N} {α}_{i}^{2} ) + {𝒳}_{N}^{2} + 2 𝒩 ( 0 , 1 ) {\sum }_{i = 1}^{N} {α}_{i} ]\end{matrix}$$

if the exact values of the mean and variance are used. The distribution of S is denoted by F(μ,δ), where μ is the mean and δ is the standard deviation.

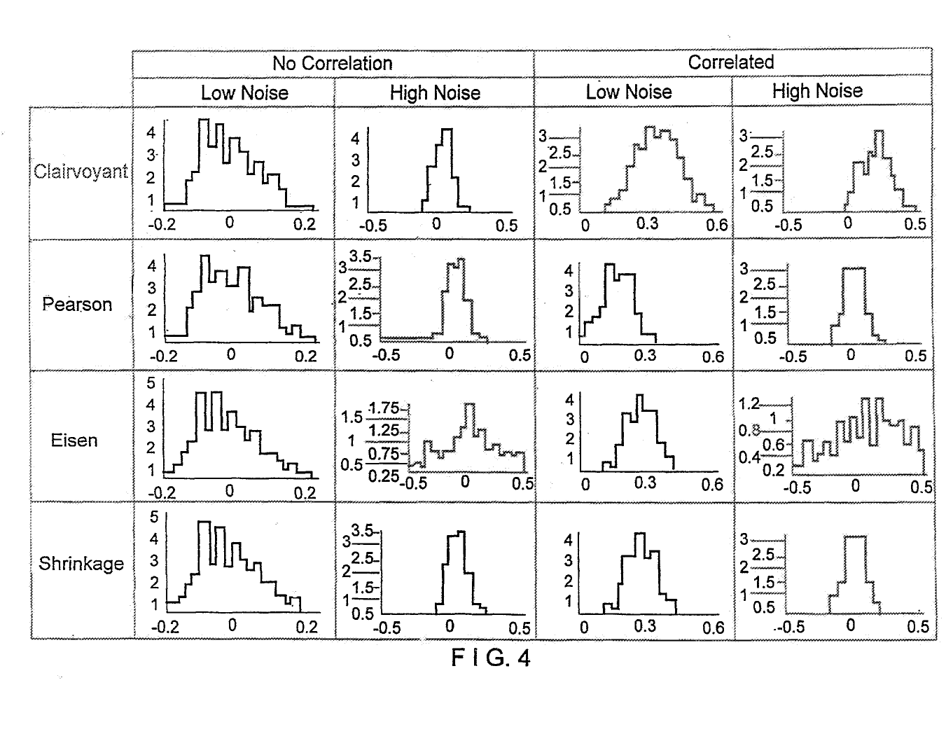

The model was implemented in Mathematica (See Wolfram (“Wolfram”), The Mathematica Book. Cambridge University Press, 4th Ed. (1999), the disclosure of which is incorporated herein by reference in its entirety). The following parameters were used in the simulation: N=10, τε{0.1, 10.0} (representing very low or high variability among the genes), σₓ=σ_{Y}=10.0, and α=0 representing no correlation between the genes or α˜U(0, 1) representing some correlation between the genes. Once the parameters were fixed for a particular in silico experiment, the gene-expression vectors for X and Y were generated several thousand times, and for each pair of vectors SAX, Y), S_{c}(X, Y), Sₚ(X, Y), and Sₑ(X, Y) were estimated by four different algorithms and further examined to see how the estimators of S varied over these trials. These four different algorithms estimated S according to equations (1) and (2), as follows: Clairvoyant estimated S_{c} using the true values of θ_{X}, θ_{Y}, σ_{X} and σ_{Y}; Pearson estimated Sₚ using the unbiased estimators X̅ and Y̅ of σ_{X}, and σ_{Y} (for X_{offset} and Y_{offset}), respectively; Eisen estimated Sₑ using the value 0.0 as the estimator of both σ_{X}, and σ_{Y}; and Shrinkage estimated Sₛ using the shrunk biased estimators \hat{θ}_{X} and \hat{θ}_{Y} of θ_{X} and θ_{Y}, respectively. In the latter three, the standard deviation was estimated as in equation (2). The histograms corresponding to these in silica experiments can be found in FIG. 4 (See Below). The information obtained from these conducted simulations, is as follows:

When X and Y are not correlated and the noise in the input is low (N=100, τ=0.1, and α=0), Pearson performs about the same as Eisen, Shrinkage, and Clairvoyant (S_{c}˜F(−0.000297,0.0996), Sₚ˜F(−0.000269,0.0999), Sₑ˜F(−0.000254,0.0994), and Sₛ˜F(−0.000254,0.0994)).

When X and Y are not correlated, but the noise in the input is high (N=100, τ=10.0, and α=0), Pearson performs about as well as Shrinkage and Clairvoyant, but Eisen introduces a substantial number of false-positives (S_{c}˜F(−0.000971,0.0994), Sp˜F(−0.000939,0.100), Sₑ˜F(−0.00119,0.354), and Sₛ˜F(−0.000939,0.100)).

When X and Y are correlated and the noise in the input is low (N=100, σ=0.1, and α˜U(0,1)), Pearson performs substantially worse than Eisen, Shrinkage, and Clairvoyant, and Eisen, Shrinkage, and Clairvoyant perform about equally as well. Pearson introduces a substantial number of false-negatives (S_{c}˜F(0.331,0.132), Sₚ˜F(0.0755,0.0992), Sₑ˜F(0.248,0.0915), and Sₛ˜F(0.245,0.0915)).

Finally, when X and Y are correlated and the noise in the input is high, the signal-to-noise ratio becomes extremely poor regardless of the algorithm employed (S_{c}˜F(0.333,0.133), Sₚ˜F(0.0762,0.100), Sₑ˜F(0.117,0.368), and Sₛ˜F(0.0762,0.0999)).

In summary, Pearson tends to introduce more false negatives and Eisen tends to introduce more false positives than Shrinkage. Exemplary Shrinkage procedures according to the present invention, on the other hand, can reduce these errors by combining the positive properties of both algorithms.

### b. Biological Example

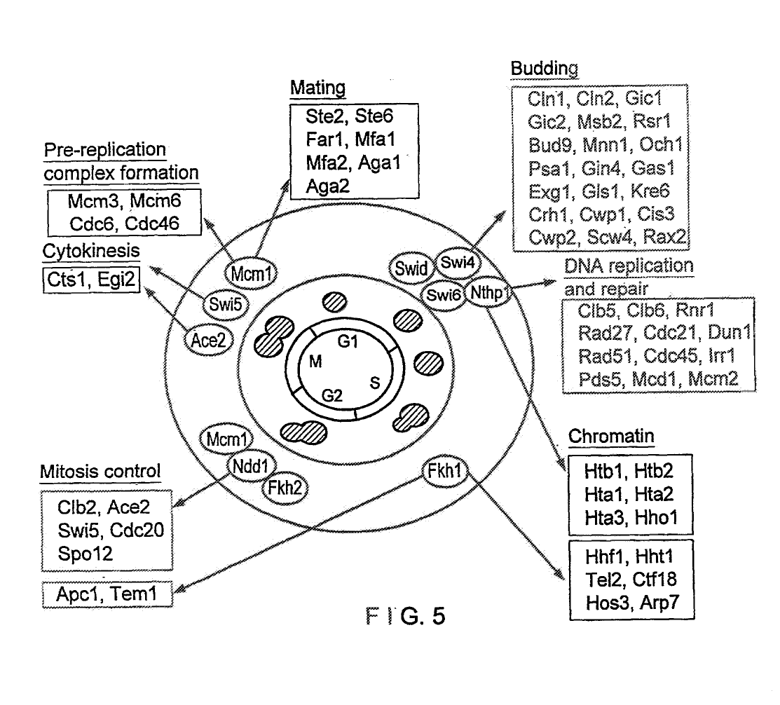

Exemplary algorithms also were tested on a biological example. A biologically well-characterized system was selected, and the clusters of genes involved in the yeast cell cycle were analyzed. These clusters were computed using the hierarchical clustering algorithm with the underlying similarity measure chosen from the following three: Pearson, Eisen, or Shrinkage. As a reference, the computed clusters were compared to the ones implied by the common cell-cycle functions and regulatory systems inferred from the roles of various transcriptional activators (See description associated with FIG. 5 below).

The experimental analysis was based on the assumption that the groupings suggested by the ChIP (Chromatin ImmunoPrecipitation) analysis are correct and thus, provide a direct approach to compare various correlation coefficients. It is possible that the ChIP-based groupings themselves contain several false relations (both positives and negatives). Nevertheless, the trend of reduced false positives and false negatives using shrinkage analysis appears to be consistent with the mathematical simulation set forth above.

In Simon et al. (“Simon”), Cell 106, 697-708 (2001), the disclosure of which is incorporated herein by reference in its entirety, genome-wide location analysis is used to determine how the yeast cell cycle gene expression program is regulated by each of the nine known cell cycle transcriptional activators: Ace2, Fkh1, Fkh2, Mbp1, Mcm1, Ndd1, Swi4, Swi5, and Swi6. It was also determined that cell cycle transcriptional activators which function during one stage of the cell cycle regulate transcriptional activators that function during the next stage. According to an exemplary embodiment of the present invention, these serial regulation transcriptional activators, together with various functional properties, can be used to partition some selected cell cycle genes into nine clusters, each one characterized by a group of transcriptional activators working together and their functions (see Table 1). For example, Group 1 may characterized by the activators Swi4 and Swi6 and the function of budding; Group 2 may be characterized by the activators Swi6 and Mbp1 and the function involving DNA replication and repair at the juncture of G1 and S phases, etc.

The hypothesis in this exemplary embodiment of the present invention can be summarized as follows: genes expressed during the same cell cycle stage (and regulated by the same transcriptional activators) can be in the same cluster. Provided below are exemplary deviations from this hypothesis that are observed in the raw data.

### Possible False Positives:

Bud9 (Group 1: Budding) and {Cts1, Egt2} (Group 7: Cytokinesis) can be placed in the same cluster by all three metrics: P49=S82≅E47; however, the Eisen metric also places Exg1 (Group 1) and Cdc6 (Group 8: Pre-replication complex formation) in the same cluster.

Mcm2 (Group 2: DNA replication and repair) and Mcm3 (Group 8) can be placed in the same cluster by all three metrics: P10=S20≅E73; however, the Eisen metric places several more genes from different groups in the same cluster: {Rnr1, Rad27, Cdc21, Dun1, Cdc45} (Group 2), Hta3 (Group 3: Chromatin), and Mcm6 (Group 8) are also placed in cluster E73.

TABLE 1
Genes in our data set, grouped by transcriptional activators
and cell-cycle functions.

| | Activators | Genes | Functions |
|---|---|---|---|
| 1 | Swi4, Swi6 | Cln1, Cln2, Gic1, Gic2, | Budding |
| | | Msb2, Rsr1, Bud9, | |
| | | Mnn1, Och1, Exg1, | |
| | | Kre6, Cwp1 | |
| 2 | Swi6, Mbp1 | Clb5, Clb6, Rnr1, | DNA replication |
| | | Rad27, Cdc21, Dun1, | and repair |
| | | Rad51, Cdc45, Mcm2 | |
| 3 | Swi4, Swi6 | Htb1, Htb2, Hta1, | Chromatin |
| | | Hta2, Hta3, Hho1 | |
| 4 | Fkh1 | Hhf1, Hht1, Tel2, Arp7 | Chromatin |
| 5 | Fkh1 | Tem1 | Mitosis Control |
| 6 | Ndd1, Fkh2, | Clb2, Ace2, Swi5, | Mitosis Control |
| | Mcm1 | Cdc20 | |
| 7 | Ace2, Swi5 | Cts1, Egt2 | Cytokinesis |
| 8 | Mcm1 | Mcm3, Mcm6, Cdc6, | Pre-replication |
| | | Cdc46 | complex formation |
| 9 | Mcm1 | Ste2, Far1 | Mating |

### Possible False Negatives:

Group 1: Budding (Table 1) may be split into four clusters by the Eisen metric: {Cln1, Cln2, Gic2, Rsr1, Mnn1}εCluster a (E39), Gic2εCluster b (E62), {Bud9, EXg1}εCluster c (E47), and {Kre6, Cwp1}εCluster d (E66); and into six clusters by both the Shrinkage and Pearson metrics: {Cln1, Cln2, Gic2, Rsr1, Mtm1}εCluster a (S3=P66), {Gic1, Kre6}εCluster b (S39=P17), Msb2εCluster c (S24=P71), Bud9εCluster d (S82=P49), Exg1εCluster e (S48=P78), and Cwp1εCluster f (S8=P4).

Table 1 contains those genes from FIG. 5 that were present in an evaluated data set. The following tables contain these genes grouped into clusters by an exemplary hierarchical clustering algorithm according to the present invention using the three metrics (Eisen in Table 2, Pearson in Table 3, and Shrinkage in Table 4) threshold at a correlation coefficient value of 0.60. The choice of the threshold parameter is discussed further below. Genes that have not been grouped with any others at a similarity of 0.60 or higher are not included in the tables. In the subsequent analysis they can be treated as singleton clusters.

TABLE 2
Eisen Clusters

| | | |
|---|---|---|
| E39 | Swi4/Swi6 | Cln1, Cln2, Gic2, Rsr1, Mnn1 |
| E62 | Swi4/Swi6 | Gic1 |
| E47 | Swi4/Swi6 | Bud9, Exg1 |
| | Ace2/Swi5 | Cts1, Egt2 |
| | Mcm1 | Cdc6 |
| E66 | Swi4/Swi6 | Kre6, Cwp1 |
| E71 | Swi6/Mbp1 | Clb5, Clb6, Rad51 |
| | Fkh1 | Tel2 |
| | Ndd1/Fkh2/Mcm1 | Cdc20 |
| | Mcm1 | Cdc46 |
| E73 | Swi6/Mbp1 | Rnr1, Rad27, Cdc21, Dun1, |
| | | Cdc45, Mcm2 |
| | Swi4/Swi6 | Hta3 |
| | Mcm1 | Mcm3, Mcm6 |
| E63 | Swi4/Swi6 | Htb1, Htb2, Hta1, Hta2, Hho1 |
| | Fkh1 | Hhf1, Hht1 |
| E32 | Fkh1 | Arp7 |
| E38 | Fkh1 | Tem1 |
| | Ndd1/Fkh2/Mcm1 | Clb2, Ace2, Swi5 |
| E51 | Mcm1 | Ste2, Far1 |

TABLE 3
Pearson Clusters

| | | |
|---|---|---|
| P66 | Swi4/Swi6 | Cln1, Cln2, Gic2, Rsr1, Mnn1 |
| P17 | Swi4/Swi6 | Gic1, Kre6 |
| P71 | Swi4/Swi6 | Msb2 |
| P49 | Swi4/Swi6 | Bud9 |
| | Ace2/Swi5 | Cts1, Egt2 |
| P78 | Swi4/Swi6 | Exg1 |
| P4 | Swi4/Swi6 | Cwp1 |
| P12 | Swi6/Mbp1 | Clb1, Clb6, Rnr1, Cdc21, Dun1, |
| | | Rad51, Cdc45 |
| | Swi4/Swi6 | Hta3 |
| | Fkh1 | Tel2 |
| | Ndd1/Fkh2/Mcm1 | Cdc20 |
| | Mcm1 | Mcm6, Cdc46 |
| P10 | Swi6/Mbp1 | Mcm2 |
| | Mcm1 | Mcm3 |
| P54 | Swi4/Swi6 | Htb1, Htb2, Hta1, Hta2, Hho1 |
| | Pkh1 | Hhf1, Hht1 |
| P37 | Fkh1 | Arp7 |
| P16 | Ndd1/Fkh2/Mcm1 | Clb2, Ace2, Swi5 |
| P50 | Mcm1 | Ste2, Far1 |

TABLE 4
Shrinkage Clusters

| | | |
|---|---|---|
| S3 | Swi4/Swi6 | Cln1, Cln2, Gic2, Rsr1, Mnn1 |
| S39 | Swi4/Swi6 | Gic1, Kre6 |
| S21 | Swi4/Swi6 | Msb2 |
| S82 | Swi4/Swi6 | Bud6 |
| | Ace2/Swi5 | Cts1, Egt2 |
| S48 | Swi4/Swi6 | Exp1 |
| S8 | Swi4/Swi6 | Cwp1 |
| S14 | Swi6/Mbp1 | Clb5, Clh6, Rnr1, Cdc21, Dun1, |
| | | Rad51, Cdc45 |
| | Fkh1 | Tel2 |
| | Ndd1/Fkh2/Mcm1 | Cdc20 |
| | Mcm1 | Mcm6, Cdc46 |
| S20 | Swi6/Mbp1 | Mcm2 |
| | Mcm1 | Mcm3 |
| S4 | Swi4/Swi6 | Htb1, Htb2, Hta1, Hta2, Hho1 |
| | Fkh1 | Hhf1, Hht1 |
| S13 | Swi4/Swi6 | Hta3 |
| S63 | Fkh1 | Arp7 |
| S22 | Ndd1/Fkh2/Mcm1 | Clb2, Ace2, Swi5 |
| S83 | Mcm1 | Ste2, Far1 |

The value γ=0.89 estimated from the raw yeast data appears to be greater than a ₇ value based equation [1]. Moreover, the value γ=0 performed better than γ=1. Such value also appears not to have yielded as great an improvement in the yeast data clusters as the simulations indicated. This exemplary result indicates that the true value of γ may be closer to 0. Upon a closer examination of the data, it can be observed that it may be possible that the data in its raw “pre-normalized” form is inconsistent with the assumptions used in deriving γ:
1. The gene vectors are not range-normalized, so βⱼ²≠β² for every j; and
2. The N experiments are not necessarily independent.

### Corrections

The first observation may be compensated for by normalizing all gene vectors with respect to range (dividing each entry in gene X by (Xₘₐₓ−Xₘᵢₙ)), recomputing the estimated, value, and repeating the clustering process. As normalized gene expression data yielded the estimate γ≅0.91 appears to be too high a value, an extensive computational experiment was conducted to determine the best empirical γ value by also clustering with the shrinkage factors of 0.2, 0.4, 0.6, and 0.8. The clusters taken at the correlation factor cut-off of 0.60, as above, are presented in Tables 5, 6, 7, 8, 9, 10 and 11.

TABLE 5
RN Data, γ = 0.0 (Elsen Clusters)

| | | |
|---|---|---|
| E8 | Swi4/Swi6 | Cla1, Msb2, Mun1 |
| E71 | Swi4/Swi6 | Cla2, Rsr1 |
| | Swi6/Mbp1 | Clb5, Clb6, Rnr1, Rad27, Cdc21, |
| | | Dun1, Rad51, Cdc15 |
| | Swi4/Swi6 | Htn3 |
| | Fkh1 | Tel2 |
| | Ndd1/Fkh2/Mcm1 | Cdc20 |
| | Mcm1 | Mcm6, Cdc46 |
| E14 | Swi4/Swi6 | Gla1 |
| E17 | Swi4/Swi6 | Bud9 |
| | Ace2/Swi5 | Cts1, Egt2 |
| | Mcm1 | Ste2, Phr1 |
| E16 | Swi4/Swi6 | Exg1 |
| E50 | Swi4/Swi6 | Kra6 |
| E18 | Swi6/Mhp1 | Mcm2 |
| | Mcm1 | Mcm3 |
| E86 | Swi4/Swi6 | Htb1, Htb2, Hta1, Hta2, Hha1 |
| | Fkh1 | Hhf1, Hht1 |
| E10 | Fkh1 | Arp7 |
| E19 | Fkh1 | Tem1 |
| | Ndd1/Fkh2/Mcm1 | Clb2, Aco2, Swi5 |
| E11 | Mcm1 | Cdc6 |

TABLE 6
Range-normalized data, γ = 0.2

| | | |
|---|---|---|
| S_{0.2}50 | Swi4/Swi6 | Gln1, Gic2, Rsr1, Mun1 |
| S_{0.2}26 | Swi4/Swi6 | Cln2 |
| | Swi6/Mbp1 | Clb5, Rnr1, Rad27, Cdc21, Dun1, |
| | | Rad51, Cdc45 |
| S_{0.2}23 | Swi4/Swi6 | Gic1 |
| S_{0.2}58 | Swi4/Swi6 | Bud9 |
| | Aco2/Swi5 | Cts1, Egt2 |
| S_{0.2}57 | Swi4/Swi6 | Exg1 |
| | Fkh1 | Arp7 |
| S_{0.2}61 | Swi4/Swi6 | Kre6 |
| S_{0.2}18 | Swi6/Mbp1 | Clb5 |
| | Swi4/Swi6 | Hta3 |
| | Fkh1 | Tel2 |
| | Ndd1/Fkh2/Mcm1 | Cdc20 |
| | Mcm1 | Mcm6, Cdc46 |
| S_{0.2}23 | Swi6/Mbp1 | Mcm2 |
| | Mcm1 | Mcm3 |
| S_{0.2}25 | Swi4/Swi6 | Htb1, Htb2, Hta1, Hta2, Hha1 |
| | Fkh1 | Hhf1, Hht1 |
| S_{0.2}20 | Fkh1 | Tem1 |
| | Ndd1/Fkh2/Mcm1 | Clb2, Aco2, Swi6 |
| S_{0.2}4 | Mcm1 | Ste2 |
| S_{0.2}55 | Mcm1 | Far1 |

TABLE 7
Range-normalized data, γ = 0.4

| | | |
|---|---|---|
| S_{0.4}64 | Swi4/Swi6 | Gln1, Gic2, Rsr1, Mnn1 |
| S_{0.4}13 | Swi4/Swi6 | Cln2 |
| | Swi6/Mbp1 | Clb5, Clb6, Rnr1, Rad27, Cdc21, |
| | | Dun1, Rad51, Cdc46 |
| | Swi4/Swi6 | Htn3 |
| | Fkh1 | Tel3 |
| | Ndd1/Fkh2/Mcm1 | Cdc20 |
| | Mcm1 | Mcm6, Cdc46 |
| S_{0.4}44 | Swi4/Swi6 | Gic1, Kre6 |
| S_{0.4}27 | Swi4/Swi6 | Msb2 |
| S_{0.4}46 | Swi4/Swi6 | Bud9 |
| | Aco2/Swi5 | Cts1, Egt2 |
| S_{0.4}73 | Swi4/Swi6 | Exg1 |
| S_{0.4}2 | Swi6/Mbp1 | Mcm2 |
| | Mcm1 | Mcm3 |
| S_{0.4}48 | Swi4/Swi6 | Htb1, Htb2, Hta1, Hta2, Hha1 |
| | Fkh1 | Hhf1, Hht1 |
| S_{0.4}26 | Fkh1 | Arp7 |
| S_{0.4}25 | Fkh1 | Tem1 |
| | Ndd1/Fkh3/Mcm1 | Cld2, Ace2, Swi5 |
| S_{0.4}16 | Mcm1 | Cdc6 |
| S_{0.4}47 | Mcm1 | Ste2 |
| S_{0.4}58 | Mcm1 | Far1 |

TABLE 8
Range-normalized data, γ = 0.6

| | | |
|---|---|---|
| S_{0.6}34 | Swi4/Swi6 | Gln1, Gic2, Rsr1, Mun1 |
| S_{0.6}77 | Swi4/Swi6 | Cln2 |
| | Swi6/Mbp1 | Clb5, Clb6, Rnr1, Rad27, Cdc21, |
| | | Dun1, Rad51, Cdc45 |
| | Swi4/Swi6 | Hta3 |
| | Fkh1 | Tel2 |
| | Ndd1/Fkh2/Mcm1 | Cdc20 |
| | Mcm1 | Mcm6, Cdc46 |
| S_{0.6}35 | Swi4/Swi6 | Gic1, Kre6 |
| S_{0.6}47 | Swi4/Swi6 | Msb2 |
| S_{0.6}62 | Swi4/Swi6 | Bud9 |
| | Aco2/Swi5 | Cts1, Egt2 |
| S_{0.6}20 | Swi4/Swi6 | Exg1 |
| S_{0.6}73 | Swi6/Mbp1 | Mcm2 |
| | Mcm1 | Mcm3 |
| S_{0.6}91 | Swi4/Swi6 | Htb1, Htb2, Hta1, Hta2, Hha1 |
| | Fkh1 | Hhf1, Hht1 |
| S_{0.6}48 | Fkh1 | Arp7 |
| S_{0.6}37 | Ndd1/Fkh2/Mcm1 | Clb2, Ace2, Swi5 |
| S_{0.6}64 | Mcm1 | Ste2 |
| S_{0.6}63 | Mcm1 | Far1 |

TABLE 9
Range-normalized data, γ = 0.8

| | | |
|---|---|---|
| S_{0.8}51 | Swi4/Swi6 | Gln1, Gic2, Rsr1, Mnn1 |
| S_{0.8}7 | Swi4/Swi6 | Cln2 |
| | Swi6/Mbp1 | Clb5, Clb6, Rnr1, Rad27, Cdc21, |
| | | Dun1, Rad51, Cdc45 |
| | Swi4/Swi6 | Htn3 |
| | Fkh1 | Tel2 |
| | Ndd1/Fkh2/Mcm1 | Cdc20 |
| | Mcm1 | Mcm6, Cdc46 |
| S_{0.8}64 | Swi4/Swi6 | Gic1, Kre6 |
| S_{0.8}90 | Swi4/Swi6 | Msb2 |
| S_{0.8}31 | Swi4/Swi6 | Bud9 |
| | Aco2/Swi5 | Cts1, Egt2 |
| S_{0.8}43 | Swi4/Swi6 | Exg1 |
| S_{0.8}65 | Swi4/Swi6 | Cwp1 |
| S_{0.8}13 | Swi6/Mbp1 | Mcm2 |
| | Mcm1 | Mcm3 |
| S_{0.8}17 | Swi4/Swi6 | Htb1, Htb2, Hta1, Hta2, Hha1 |
| | Fkh1 | Hhf1, Hht1 |
| S_{0.8}76 | Fkh1 | Arp7 |
| S_{0.8}74 | Ndd1/Fkh2/Mcm1 | Clb2, Ace2, Swi5 |
| S_{0.8}33 | Mcm1 | Ste2 |
| S_{0.8}32 | Mcm1 | Far1 |

TABLE 10
RN Data, γ = 0.91 (Shrinkage Clusters)

| | | |
|---|---|---|
| S49 | Swi4/Swi6 | Cln1, Gic2, Rsr1, Mnn1 |
| S73 | Swi4/Swi6 | Cln2 |
| | Swi6/Mbp1 | Clb5, Clb6, Rnr1, Rad27, Cdc21, |
| | | Dun1, Rad51, Cdc45 |
| | Swi4/Swi6 | Hta3 |
| | Fkh1 | Tel2 |
| | Ndd1/Fkh2/Mcm1 | Cdc20 |
| | Mcm1 | Mcm6, Cdc46 |
| S45 | Swi4/Swi6 | Gic1, KreG |
| S15 | Swi4/Swi6 | Msb2 |
| S90 | Swi4/Swi6 | Bud9 |
| | Ace2/Swi5 | Cts1, Egt2 |
| S56 | Swi4/Swi6 | Exg1 |
| S46 | Swi4/Swi6 | Cwp1 |
| S71 | Swi6/Mbp1 | Mcm2 |
| | Mcm1 | Mcm3 |
| S61 | Swi4/Swi6 | Htb1, Htb2, Hta1, Hta2, Hho1 |
| | Fkh1 | Hhf1, Hht1 |
| S37 | Fkh1 | Arp7 |
| S7 | Ndd1/Fkh2/Mcm1 | Clb2, Ace2, Swi5 |
| S91 | Mcm1 | Ste2 |
| S92 | Mcm1 | Far1 |

TABLE 11
RN Data, γ = 1.0 (Pearson Clusters)

| | | |
|---|---|---|
| P10 | Swi4/Swi6 | Cln1, Gic2, Rsr1, Mnn1 |
| P68 | Swi4/Swi6 | Cln2 |
| | Swi6/Mbp1 | Clb5, Clb6, Rnr1, Rad27, Cdc21, |
| | | Dun1, Rad51, Cdc45 |
| | Swi4/Swi6 | Hta3 |
| | Fkh1 | Tel2 |
| | Ndd1/Fkh2/Mcm1 | Cdc20 |
| | Mcm1 | Mcm6, Cdc46 |
| P1 | Swi4/Swi6 | Gic1, KreG |
| P39 | Swi4/Swi6 | Msb2 |
| P66 | Swi4/Swi6 | Bud9 |
| | Ace2/Swi5 | Cts1, Egt2 |
| P20 | Swi4/Swi6 | Exg1 |
| P2 | Swi4/Swi6 | Cwp1 |
| P72 | Swi6/Mbp1 | Mcm2 |
| | Mcm1 | Mcm3 |
| P53 | Swi4/Swi6 | Htb1, Htb2, Hta1, Hta2, Hho1 |
| | Fkh1 | Hhf1, Hht1 |
| P12 | Fkh1 | Arp7 |
| P46 | Ndd1/Fkh2/Mcm1 | Clb2, Ace3, Swi5 |
| P64 | Mcm1 | Ste2 |
| P65 | Mcm1 | Far1 |

To compare the resulting sets of clusters, the following notation may be introduced. Each cluster set may be written, as follows:

$${\{ x \{ \{ {y}_{1} , {z}_{1} \} , \{ {y}_{2} , {z}_{2} \} , … , \{ {y}_{{n}_{ω}} , {z}_{{n}_{ω}} \} \} \}}_{x = 1}^{\# of groups}$$

where x denotes the group number (as described in Table 1), nₓ is the number of clusters group x appears in, and for each cluster jε{1, . . . , nₓ}, where are yⱼ genes from group x and zⱼ genes from other groups in Table 1. A value of “*” for zⱼ denotes that cluster j contains additional genes, although none of them are cell cycle genes; in subsequent computations, this value may be treated as 0.

This notation naturally lends itself to a scoring function for measuring the number of false positives, number of false negatives, and total error score, which aids in the comparison of cluster sets.

$$\begin{matrix}FP ( γ ) = \frac{1}{2} {\sum }_{x} {\sum }_{j = 1}^{{n}_{x}} {y}_{j} \cdot {z}_{j} & ( 15 ) \\ FN ( γ ) = {\sum }_{x} {\sum }_{1 \leq j < k \leq {n}_{x}} {y}_{j} \cdot {y}_{k} & ( 16 ) \\ Error\_score ( γ ) = FP ( γ ) + FN ( γ ) & ( 17 )\end{matrix}$$

| γ = 0.0(E) [symbol] | |
|---|---|
| {1 → | {{3, *}, {2, 13}, {1, *}, {1, *}, |
| | {1, *}, {1, 4}, {1, 0}, {1, 0}, {1, 0}}, |
| 2 → | {{8, 7}, {1, 1}}, |
| 3 → | {{5, 2}, {1, 14}}, |
| 4 → | {{2, 5}, {1, 14}, {1, *}}, |
| 5 → | {{1, 3}}, |
| 6 → | {{3, 1}, {1, 14}}, |
| 7 → | {{2, 3}}, |
| 8 → | {{2, 13}, {1, 1}, {1, 0}}, |
| 9 → | {{2, 3}} |
| } | |
| Error_score(0.0) = 97 + 88 = 185 | |
| γ = 0.2 [symbol] | |
| {1 → | {{4, *}, {1, 7}, {1, *}, {1, *}, |
| | {1, 1}, {1, 2}, {1, 0}, {1, 0}, {1, 0}}, |
| 2 → | {{7, 1}, {1, 5}, {1, 1}}, |
| 3 → | {{5, 2}, {1, 5}}, |
| 4 → | {{2, 5}, {1, 5}, {1, 1}}, |
| 5 → | {{1, 3}}, |
| 6 → | {{3, 1}, {1, 5}}, |
| 7 → | {{2, 1}}, |
| 8 → | {{2, 4}, {1, 1}, {1, 0}}, |
| 9 → | {{1, *}, {1, *}} |
| } | |

Error_score(0.2) = 38 + 94 = 132

In such notation, the cluster sets with their error scores can be listed as follows:

| γ = 0.4 [symbol] | | °γ = 0.6 [symbol] | |
|---|---|---|---|
| {1 → | {{4, *}, {1, 13}, {1, *}, | {1 → | {{4, *}, {1, 13}, {1, *}, |
| | {1, *}, {2, *}, {1, 2}, | | {1, *}, {2, *}, {1, 2}, |
| | {1, 0}, {1, 0}}, | | {1, 0}, {1, 0}}, |
| 2 → | {{8, 6}, {1, 1}}, | 2 → | {{8, 6}, {1, 1}}, |
| 3 → | {{5, 2}, {1, 13}}, | 3 → | {{5, 2}, {1, 13}}, |
| 4 → | {{2, 5}, {1, 3}, {1, *}}, | 4 → | {{2, 5}, {1, 13}, {1, *}}, |
| 5 → | {{1, 3}}, | 5 → | {{1, 0}}, |
| 6 → | {{3, 1}, {1, 13}}, | 6 → | {{3, *}, {1, 13}}, |
| 7 → | {{2, 1}}, | 7 → | {{2, 1}}, |
| 8 → | {{2, 12}, {1, *}, {1, 1}}, | 8 → | {{2, 12}, {1, 1}, {1, 0}}, |
| 9 → | {{1, *}, {1, *}} | 9 → | {{1, *}, {1, *}} |
| } | | } | |

| | |
|---|---|
| Error_score(0.4) = 78 + 86 = | Error_score(0.6) = 75 + 86 = |
| 164 | 161 |

Error_score(0.6)=75+86=161.

| γ = 0.91(S) [symbol] | |
|---|---|
| {1 → | {{4, *}, {1, 13}{1, *}, {1, *}, |
| | {1, *}, {2, *}, {1, 2}, {1, 0}}, |
| 2 → | {{8, 6}, {1, 1}}, |
| 3 → | {{5, 2}, {1, 13}}, |
| 4 → | {{2, 5}, {1, 13}, {1, *}}, |
| 5 → | {{1, 0}}, |
| 6 → | {{3, *}, {1, 13}}, |
| 7 → | {{2, 1}}, |
| 8 → | {{2, 12}, {1, 1}, {1, 0}}, |
| 9 → | {{1, *}, {1, *}} |
| } | |
| γ = 0.8 [symbol] | |
| {1 → | {{4, *}, {1, 13}, {1, *}, {1, *}, |
| | {1, *}, {2, *}, {1, 2}, {1, 0}}, |
| 2 → | {{8, 0}, {1, 1}}, |
| 3 → | {{5, 2}, {1, 13}}, |
| 4 → | {{2, 5}, {1, 13}, {1, *}}, |
| 5 → | {{1, 0}}, |
| 6 → | {{3, *}, {1, 13}}, |
| 7 → | {{2, 1}}, |
| 8 → | {{2, 12}, {1, 1}, {1, 0}}, |
| 9 → | {{1, *}, {1, *}} |
| } | |

Error_score(0.8) = 75 + 86 = 161

Error_score(0.91)=75+86=161.

| γ = 1.0(P) [symbol] | |
|---|---|
| {1 → | {{4, *}, {1, 13}, {1, *}, {1, *}, |
| | {1, *}, {2, *}, {1, 2}, {1, 0}}, |
| 2 → | {{8, 6}, {1, 1}}, |
| 3 → | {{5, 2}, {1, 13}}, |
| 4 → | {{2, 5}, {1, 13}, {1, *}}, |
| 5 → | {{1, 0}}, |
| 6 → | {{3, *}, {1, 13}}, |
| 7 → | {{2, 1}}, |
| 8 → | {{2, 12}, {1, 1}, {1, 0}}, |
| 9 → | {{1, *}, {1, *}} |
| } | |

Error_score(1.0) = 75 + 86 = 161

In this notion, γ values of 0.8, 0.91, and 1.0 provide substantially identical cluster groupings, and the likely best error score may be attained at γ=0.2.

To improve the estimated value of γ, the statistical dependence among the experiments may be compensated for by reducing the effective number of experiments by subsampling from the set of all (possibly correlated) experiments. The candidates can be chosen via clustering all the experiments, columns of the data matrix, and then selecting one representative experiment from each cluster of experiments. The subsampled data may then be clustered, once again using the cut-off correlation value of 0.60. The exemplary resulting cluster sets under the Eisen, Shrinkage, and Pearson metrics are given in Tables 12, 13, and 14, respectively.

TABLE 12
RN Subsampled Data, γ = 0.0 (Eisen)

| | | |
|---|---|---|
| E53 | Swi4/Swi6 | Cln1, Och1 |
| E63 | Swi4/Swi6 | Cln2, Msb2, Rsr1, Bud9, Mnn1, |
| | | Exg1 |
| | Swi6/Mbp1 | Rur1, Rad27, Cdc21, Dun1, |
| | | Rad51, Cdc45, Mcm2 |
| | Swi4/Swi6 | Htb1, Htb2, Hta1, Hta2, Hho1 |
| | Fkh1 | Hhf1, Hht1, Arp7 |
| | Fkh1 | Tem1 |
| | Ndd1/Fkh2/Mcm1 | Clb2, Ace2, Swi5 |
| | Ace2/Swi5 | Egt2 |
| | Mcm1 | Mcm3, Mcm6, Cdc6 |
| E29 | Swi4/Swi6 | Gic1 |
| E64 | Swi4/Swi6 | Gic2 |
| E33 | Swi4/Swi6 | Kre6, Cwp1 |
| | Swi6/Mbp1 | Clb5, Clb6 |
| | Swi4/Swi6 | Hta3 |
| | Ndd1/Fkh2/Mcm1 | Cdc20 |
| | Mcm1 | Cdc46 |
| E73 | Fkh1 | Tel2 |
| E23 | Ace2/Swi5 | Cts1 |
| E43 | Mcm1 | Ste2 |
| E66 | Mcm1 | Far1 |

TABLE 13
RN Subsampled Data, γ = 0.66 (Shrinkage)

| | | |
|---|---|---|
| S49 | Swi4/Swi6 | Cln1, Bud9, Och1 |
| | Ace2/Swi5 | Egt2 |
| | Mcm1 | Cdc6 |
| S6 | Swi4/Swi6 | Cln2, Gic2, Msb2, Rsr1, Mnn1, |
| | | Exg1 |
| | Swi6/Mbp1 | Rnr1, Rad27, Cdc21, Dun1, |
| | | Rad51, Cdc45 |
| S32 | Swi4/Swi6 | Gic1 |
| S65 | Swi4/Swi6 | KreG, Cwp1 |
| | Swi6/Mbp1 | Clb5, Clb6 |
| | Fkh1 | Tel2 |
| | Ndd1/Fkh2/Mcm1 | Cdc20 |
| | Mcm1 | Cdc46 |
| S15 | Swi6/Mbp1 | Mcm2 |
| | Mcm1 | Mcm3 |
| S11 | Swi4/Swi6 | Htb1, Htb2, Hta1, Hta2, Hho1 |
| | Fkh1 | Hhf1, Hht1 |
| S60 | Swi4/Swi6 | Hta3 |
| S30 | Fkh1 | Arp7 |
| | Ndd1/Fkh2/Mcm1 | Clb2, Ace2, Swi5 |
| S62 | Fkh1 | Tem1 |
| S53 | Ace2/Swi5 | Cts1 |
| S14 | Mcm1 | Mcm6 |
| S35 | Mcm1 | Ste2 |
| S36 | Mcm1 | Far1 |

TABLE 14
RN Subsampled Data, γ = 1.0 (Pearson)

| | | |
|---|---|---|
| P1 | Swi4/Swi6 | Cln1, Och1 |
| P15 | Swi4/Swi6 | Cln2, Rsr1, Mnn1 |
| | Swi6/Mbp1 | Cdc21, Dun1, Rad51, Cdc45, Mcm2 |
| | Mcm1 | Mcm3 |
| P29 | Swi4/Swi6 | Gin1 |
| P2 | Swi4/Swi6 | Gin2 |
| P3 | Swi4/Swi6 | Msh2, Exg1 |
| | Swi6/Mbp1 | Rnr1 |
| P51 | Swi4/Swi6 | Bud9 |
| | Ndd1/Fkh2/Mcm1 | Clb2, Ace2, Swi5 |
| | Ace2/Swi5 | Egt2 |
| | Mcm1 | Cdc5 |
| P11 | Swi4/Swi6 | KreG |
| P62 | Swi4/Swi6 | Cwp1 |
| | Swi6/Mbp1 | Clb5, Clb6 |
| | Swi4/Swi6 | Hta3 |
| | Ndd1/Fkh2/Mcm1 | Cdc30 |
| | Mcm1 | Cdc46 |
| P49 | Swi6/Mbp1 | Rad27 |
| | Swi4/Swi6 | Htb1, Htb2, Hta1, Hta2, Hho1 |
| | Fkh1 | Hhf1, Hht1 |
| P10 | Fkh1 | Tel2 |
| | Mcm1 | Mcm6 |
| P23 | Fkh1 | Arp7 |
| P50 | Fkh1 | Tem1 |
| P69 | Ace2/Swi5 | Cts1 |
| P42 | Mcm1 | Ste2 |
| P13 | Mcm1 | Far1 |

The subsampled data may yield the lower estimated value≈0.66. In the exemplary set notation, the resulting clusters with the corresponding error scores can be written as follows:

| γ = 0.0(E) [symbol] | | |
|---|---|---|
| {1 → | {{6, 23}, {2, *}, {2, 5}, {1, *}, {1, *}}, | |
| 2 → | {{7, 22}, {2, 5}}, | |
| 3 → | {{5, 24}, {1, 6}}, | |
| 4 → | {{3, 20}, {1, *}}, | |
| 5 → | {{1, 28}}, | |
| 6 → | {{3, 20}, {1, 6}}, | |
| 7 → | {{1, *}, {1, 28}}, | |
| 8 → | {{3, 20}, {1, 6}}, | |
| 9 → | {{1, *}, {1, *}} | |
| } | | |
| Error_score(0.0) = 370 + 79 = 449 | | |
| γ = 0.66(S) [symbol] | | |
| {1 → | {{6, 6}, {3, 2}, {2, 5}, {1, *}}, | {1, *}}, |
| 2 → | {{6, 6}, {2, 5}, {1, 1}}, | |
| 3 → | {{5, 2}, {1, *}}, | |
| 4 → | {{2, 5}, {1, 3}, {1, 0}}, | |
| 5 → | {{1, *}}, | |
| 6 → | {{3, 1}, {1, 6}}, | |
| 7 → | {{1, *}, {1, 4}}, | |
| 8 → | {{1, *}, {1, 1}, {1, 4}, {1, 6}}, | |
| 9 → | {{1, *}, {1, *}} | |
| } | | |

| Error_score(0.66) = 76 + 88 = 164 | |
|---|---|
| γ = 1.0(P) [symbol] | |
| {1 → | {{3, 6}, {2, *}, {2, 1}, {1, *}, |
| | {1, *}, {1, *}, {1, 5}, {1, 5}}, |
| 2 → | {{5, 4}, {2, 4}, {3, 2}, {1, 7}}, |
| 3 → | {{5, 3}, {1, 5}}, |
| 4 → | {{2, 6}, {1, *}, {1, 1}}, |
| 5 → | {{1, *}}, |
| 6 → | {{3, 3}, {1, 5}}, |
| 7 → | {{1, *}, {1, 5}}, |
| 8 → | {{1, 1}, {1, 5}, {1, 5}, {1, 8}}, |
| 9 → | {{1, *}, {1, *}} |
| } | |

Error_score(1.0) = 69 + 107 = 176

From the tables for the range-normalized, subsampled yeast data, as well as by comparing the error scores, it appears that for the same clustering algorithm and threshold value, Pearson introduces more false negatives and Eisen introduces more false positives than Shrinkage. The exemplary Shrinkage procedure according to the present invention may reduce these errors by combining the positive properties of both algorithms. This observation is consistent with the mathematical analysis and simulation described above.

### General Discussion

Microarray-based genomic analysis and other similar high-throughput methods have begun to occupy an increasingly important role in biology, as they have helped to create a visual image of the state-space trajectories at the core of the cellular processes. Nevertheless, as described above, a small error in the estimation of a parameter (e.g., the shrinkage parameter) may have a significant effect on the overall conclusion. Errors in the estimators can manifest themselves by missing certain biological relations between two genes (false negatives) or by proposing phantom relations between two otherwise unrelated genes (false positives).

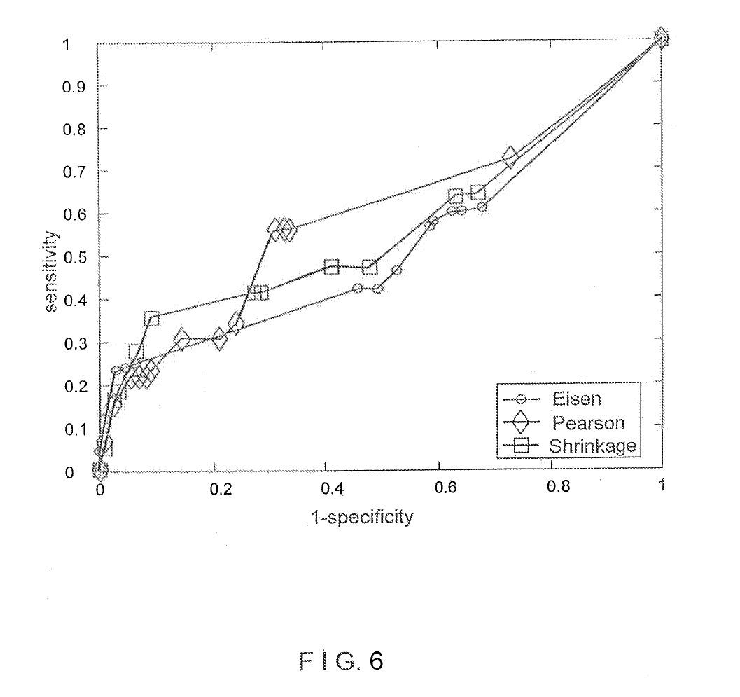

A global illustration of these interactions can be seen in an exemplary Receiver Operator Characteristic (“ROC”) graph (shown in FIG. 6) with each curve parameterized by the cut-off threshold in the range of [−1,1]. The ROC curve (see, e.g., Egan, J. P., Signal Detection Theory and ROC analysis, Academic Press, New York. (1975), the entire disclosure of which is incorporated herein by reference in its entirety) for a given metric preferably plots sensitivity against (1-specificity), where:

$$\begin{matrix}Sensitivity = fraction of positives detected by a metric \\ = \frac{TP ( γ )}{TP ( γ + FN ( γ )} ,\end{matrix}$$

$$\begin{matrix}Specificity = fraction of negatives detected by a metric \\ = \frac{TN ( γ )}{TN ( γ ) + FP ( γ )} ,\end{matrix}$$

and TP(γ), FN(γ), FP(γ) and TN(γ) denote the number of True Positives, False Negatives, False Positives, and True Negatives, respectively, arising from a metric associated with a given γ. (Recall that γ is 0.0 for Eisen, 1.0 for Pearson, and may be computed according to equation (14) for Shrinkage, which yields about 0.66 on this data set.) For each pair of genes, {j,k}, we can define these events using our hypothesis as a measure of truth:
TP: {j, k} can be in same group (see Table 1) and {j, r} can be placed in same cluster;
FP: {j, k} can be in different groups; but {j, k} can be placed in same cluster;
TN: {j, k} can be in different groups and {j, k} can be placed in different clusters; and
FN: {j, k} can be in same group, but {j, k} can be placed in different clusters.
FP(γ) and FN(γ) were already defined in equations (15) and (16), respectively, and we define

$$\begin{matrix}TP ( γ ) = {\sum }_{x} {\sum }_{j = 1}^{{n}_{x}} ( \begin{matrix}{y}_{j} \\ 2\end{matrix} ) \\ and & ( 18 ) \\ TN ( γ ) = Total - ( TP ( γ ) + FN ( γ ) + FP ( γ ) ) & ( 19 )\end{matrix}$$

where

$$Total = ( \begin{matrix}44 \\ 2\end{matrix} ) = 946$$

is the total # of gene pairs {j, k} in Table 1.
The ROC figure suggests the best threshold to use for each metric, and can also be used to select the best metric to use for a particular sensitivity.

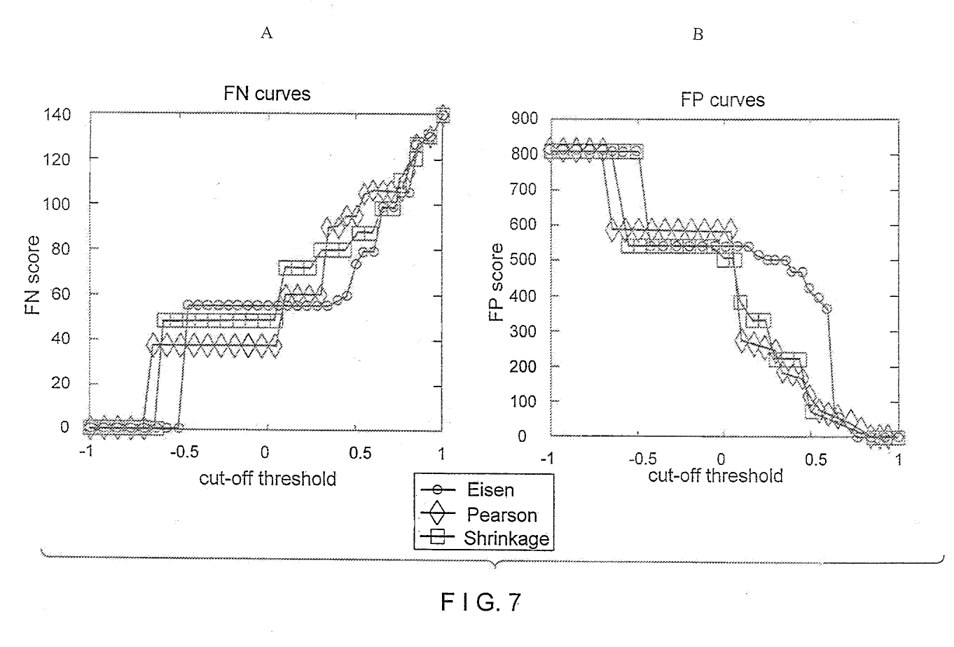

The dependence of the error scores on the threshold can be more clearly seen from an exemplary graph of FIG. 7, which shows that a threshold value of about 0.60 is a reasonable representative value.

### B. Financial Example

The algorithms of the present invention may also be applied to financial markets. For example, the algorithm may be applied to determine the behavior of individual stocks or groups of stocks offered for sale on one or more publicly-traded stock markets relative to other individual stocks, groups of stocks, stock market indices calculated from the values of one or more individual stocks, e.g., the Dow Jones 500, or stock markets as a whole. Thus, an individual considering investment in a given stock or groups of stocks in order to achieve a return on their investment greater than that provided by another stock, another group of stocks, a stock index or the market as a whole, could employ the algorithm of the present invention to determine whether the sales price of the given stock or group of stocks under consideration moves in a correlated, way is the movement of any other stock, groups of stocks, stock indices or stock markets as a whole. If there is a strong association between the movement of the price of a given stock or groups of stocks and another stock, another group of stocks, a stock index or the market as a whole, the prospective investor may not wish to assume the potentially greater risk associated with investing in a single stock when its likelihood to increase in value may be limited by the movement of the market as a whole, which is usually a less risky investment. Alternatively, an investor who knows or believes that a given stock has in the past outperformed other stocks, a stock market index, or the market as a whole, could employ the algorithm of the present invention to identify other promising stocks that are likely to behave similarly as future candidates for investment. Those skilled in the art of investment will recognize that the present invention may be applied in numerous systems, methods, and software arrangements for identifying candidate investments, not only in stock markets, but also in other markets including but not limited to the bond market, futures markets, commodities markets, etc., and the present invention is in no way limited to the exemplary applications and embodiments described herein.

The foregoing merely illustrates the principles of the present invention. Various modifications and alterations to the described embodiments will be apparent to those skilled in the art in view of the teachings herein. It will thus be appreciated that those skilled in the art will be able to devise numerous systems, methods, and software arrangements for determining associations between one or more elements contained within two or more datasets that, although not explicitly shown or described herein, embody the principles of the invention and are thus within the spirit and scope of the invention. Indeed, the present invention is in no way limited to the exemplary applications and embodiments thereof described above.

### APPENDIX

### Appendix A.1

### Receiver Operator Characteristic Curves

### Definitions

If two genes are in the same group, they may “belong in same cluster”, and if they are in different groups, they may “belong in different clusters.” Receiver Operator Characteristic (ROC) curves, a graphical representation of the number of true positives versus the number of false positives for a binary classification system as the discrimination threshold is varied, are generated for each metric used (i.e., one for Eisen, one for Pearson, and one for Shrinkage).

Event: grouping of (cell cycle) genes into clusters;
Threshold: cut-off similarity value at which the hierarchy tree is cut into clusters. The exemplary cell-cycle gene table can consist of 44 genes, which gives us C(44,2)=946 gene pairs. For each (unordered) gene pair {j, k}, define the following events:
TP: {j, k} can be in same group and {j, k} can be placed in same cluster;
FP: {j, k} can be in different groups, but {j, k} can be placed in same cluster;
TN: {j,k} can be in different groups and {j, k} can be placed in different clusters; and
FN: {j, k} can be in same group, but {j, k} can be placed in different clusters.

### Thus,

$$TP ( γ ) = {\sum }_{( j , k )} TP ( \{ j , k \} )$$

$$FP ( γ ) = {\sum }_{\{ j , k \}} FP ( \{ j , k \} )$$

$$TN ( γ ) = {\sum }_{\{ j , k \}} TN ( \{ j , k \} )$$

$$FN ( γ ) = {\sum }_{\{ j , k \}} FN ( \{ j , k \} )$$

where the sums are taken over all 946 unordered pairs of genes.
Two other quantities involved in ROC curve generation can be

$$\begin{matrix}Sensitivity = fraction of positives detected by a metric \\ = \frac{TP ( γ )}{TP ( γ + FN ( γ )} .\end{matrix}$$

$$\begin{matrix}Specificity = fraction of negatives detected by a metric \\ = \frac{TN ( γ )}{TN ( γ ) + FP ( γ )} .\end{matrix}$$

The ROC curve plots sensitivity, on the y-axis, as a function of (1-specificity), on the x-axis, with each point on the plot corresponding to a different cut-off value. A different curve was created for each of the three metrics.

The following sections describe how the quantities TP(γ), FN(γ), FP(γ), and TN(γ) can be computed using an exemplary set notation for clusters, with a relationship of:

$${\{ x -> \{ \{ {y}_{1} , {z}_{1} \} , \{ {y}_{2} , {z}_{2} \} , … , \{ {y}_{{n}_{x}} , {z}_{{n}_{x}} \} \} \}}_{x = 1}^{\# of groups}$$

### Computations

A. TP

$$TP ( γ ) = {\sum }_{\{ j , k \}} TP \{ ( j , k \} ) = \# gene pairs that were placed in same cluster and belong in same group .$$

For each group x given in set notation as

x→{{y₁,z₁}, . . . , {yₙ_{ₓ},zₙ_{ₓ}}},

pairs from each yⱼ should be counted, i.e.,

$$TP ( x ) = ( \begin{matrix}{y}_{1} \\ 2\end{matrix} ) + … + ( \begin{matrix}{y}_{nx} \\ 2\end{matrix} ) = {\sum }_{j = 1}^{{n}_{x}} ( \begin{matrix}{y}_{j} \\ 2\end{matrix} )$$

Obtaining a total over all groups yields

$$TP ( γ ) = {\sum }_{x = 1}^{\# groups} TP ( x ) = {\sum }_{x} {\sum }_{j = 1}^{{n}_{x}} ( \begin{matrix}{y}_{j} \\ 2\end{matrix} )$$

B. FN

$$FN ( γ ) = {\sum }_{\{ j , k \}} FN ( \{ j , k \} ) = \# gene pairs that belong in same group but were placed into different clusters . FN \text{?} = \{ \begin{matrix}{\sum }_{j = 1}^{{n}_{x}} {\sum }_{k = j + 1}^{{n}_{x}} \text{?} & if \text{?} \\ 0 , & if \text{?} = 1.\end{matrix} \\ \text{?} \text{indicates text missing or illegible when filed}$$

Every pair that was separated could. be counted
However, when nₓ=1, there is no pair {j, k} that satisfies the triple inequality 1≦j<k≦nₓ, and hence, it is not necessary to treat such pair as a special case.

$$∴ FN ( γ ) = {\sum }_{x = 1}^{\# groups} FN ( x ) = {\sum }_{x} \text{?}$$

$$\text{?} \text{indicates text missing or illegible when filed}$$

C. FP

$$FP ( γ ) = {\sum }_{\{ j , k \}} FP ( \{ j , k \} ) = \# gene pairs that belong in different groups but got placed in the same cluster .$$

The expression

$${\sum }_{x} {\sum }_{j = 1}^{{n}_{x}} {y}_{j} \cdot {z}_{j}$$

may count every false-positive pair {j, k} twice: first, when looking at j's group, and again, when looking at k's group.

$$∴ FP ( γ ) = \frac{1}{2} {\sum }_{x} {\sum }_{j = 1}^{{n}_{x}} {y}_{j} \cdot {z}_{j}$$

D. TN

$$TN ( γ ) = {\sum }_{\{ j , k \}} TN ( \{ j , k \} ) = \# gene pairs that belong in different groups and got placed in different clusters .$$

Instead of counting true-negatives from our notation, the fact that the other three scores are known may be used, and the total thereof can also be utilized.
Complementarily. Given a gene pair {j,k}, only one of the events {TP({j,k}), FN({j,k}), FP({j,k}), TN({j,k})} may be true. This implies

$${\sum }_{\{ j , k \}} TP ( \{ j , k \} ) + {\sum }_{\{ j , k \}} FN ( \{ j , k \} ) + {\sum }_{\{ j , k \}} FP ( \{ j , k \} ) + {\sum }_{\{ j , k \}} TN ( \{ j , k \} ) == TP ( γ ) + FN ( γ ) + FP ( γ ) + TN ( γ ) == ( \begin{matrix}44 \\ 2\end{matrix} ) = \frac{44.43}{2} = 946 = Total \\ ∴ TN ( γ ) = Total - ( TP ( γ ) + FN ( γ ) + FP ( γ ) )$$

### Plotting ROC Curves

For each cut-off value θ, TP(γ), FN(γ), FP(γ), and TN(γ) are computed as described above, with γε{0.0, 0.66, 1.0} corresponding to Eisen, Shrinkage, and Pearson, respectively. Then, the sensitivity and specificity may be computed from equations (20) and (21), and sensitivity vs. (1-specificity) can be plotted, as shown in FIG. 6.

The effect of the cut-off threshold θ on the FN and FP scores individually also can be examined, using an exemplary graph shown in FIG. 7.

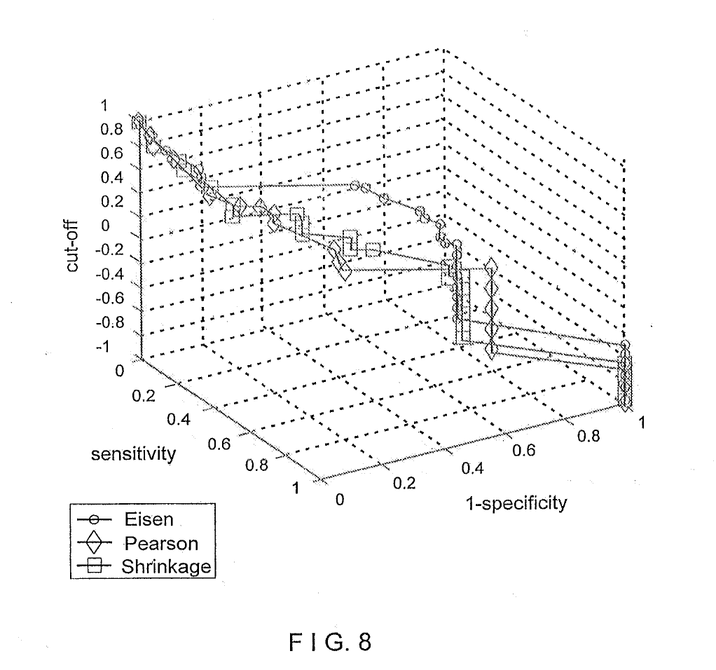

A 3-dimensional graph of (1-specificity) on the x-axis, sensitivity on the y-axis, and threshold on the z-axis offers a view shown in FIG. 8.

### A.2 Computing The Marginal PDF for Xⱼ

$$\begin{matrix} f ( {X}_{j} ) = {E}_{{θ}_{j}} f ( {X}_{j} \vert {θ}_{j} ) \\ = {\int }_{- ∞}^{∞} f ( {X}_{j} \vert θ ) π ( θ ) d θ \\ = {\int }_{- ∞}^{∞} \frac{1}{\sqrt{2 π} σ} {e}^{- \frac{{( {X}_{j} - θ )}^{2}}{2 {σ}^{2}}} \cdot \text{?} e \text{?} d θ \\ = \text{?} {\int }_{- ∞}^{∞} e \text{?} d θ\end{matrix} \\ \text{?} \text{indicates text missing or illegible when filed} \qquad ( 22 )$$

First, rewrite the exponent as a complete square:

$$\begin{matrix}\frac{{( {X}_{j} - θ )}^{2}}{{σ}^{2}} + \frac{{θ}^{2}}{{τ}^{2}} = \frac{1}{{σ}^{2} {τ}^{2}} [ {{τ}^{2} ( {X}_{j} - θ )}^{2} + {σ}^{2} {θ}^{2} ] \\ = \frac{1}{{σ}^{2} {τ}^{2}} [ {τ}^{2} {X}_{j}^{2} - 2 {τ}^{2} {X}_{j} θ + {τ}^{2} {θ}^{2} + {σ}^{2} {θ}^{2} ] \\ = \frac{1}{{σ}^{2} {τ}^{2}} [ ( {σ}^{2} + {τ}^{2} ) {θ}^{2} - 2 {τ}^{2} {X}_{j} θ + {τ}^{2} {X}_{j}^{2} ] \\ = \frac{{σ}^{2} + {τ}^{2}}{{σ}^{2} {τ}^{2}} [ {θ}^{2} - 2 \frac{{τ}^{2}}{{σ}^{2} + {τ}^{2}} {X}_{j} θ + \frac{{τ}^{2}}{{σ}^{2} + {τ}^{2}} {X}_{j}^{2} ] \\ = \frac{{σ}^{2} + {τ}^{2}}{{σ}^{2} {τ}^{2}} [ {( θ - \frac{{τ}^{2}}{{σ}^{2} + {τ}^{2}} {X}_{j} )}^{2} - \\ \underbrace{{( \frac{{τ}^{2}}{{σ}^{2} + {τ}^{2}} {X}_{j} )}^{2} + \frac{{τ}^{2}}{{σ}^{2} + {τ}^{2}} {X}_{j}^{2} ]} & ( 23 ) \\ \begin{matrix}* \frac{{τ}^{2}}{{σ}^{2} + {τ}^{2}} {X}_{j}^{2} - {( \frac{{τ}^{2}}{{σ}^{2} + {τ}^{2}} {X}_{j} )}^{2} = {X}_{j}^{2} ( \frac{{τ}^{2}}{{σ}^{2} + {τ}^{2}} ) ( 1 - \frac{{τ}^{2}}{{σ}^{2} + {τ}^{2}} ) \\ = {X}_{j}^{2} ( \frac{{τ}^{2}}{{σ}^{2} + {τ}^{2}} ) ( \frac{{σ}^{2}}{{σ}^{2} + {τ}^{2}} ) \\ = {X}_{j}^{2} \frac{{σ}^{2} {τ}^{2}}{{( {σ}^{2} + {τ}^{2} )}^{2}}\end{matrix} & ( 24 )\end{matrix}$$

Substituting (24) into (23) yields

$$\begin{matrix}\frac{{( {X}_{j} - θ )}^{2}}{{σ}^{2}} + \frac{{θ}^{2}}{{τ}^{2}} = = \frac{{σ}^{2} + {τ}^{2}}{{σ}^{2} {τ}^{2}} {( θ - \frac{{τ}^{2}}{{σ}^{2} + {τ}^{2}} {X}_{j} )}^{2} + \\ \frac{{σ}^{2} + {τ}^{2}}{{σ}^{2} {τ}^{2}} {X}_{j}^{2} \frac{{σ}^{2} {τ}^{2}}{{( {σ}^{2} + {τ}^{2} )}^{2}} \\ = \frac{{σ}^{2} + {τ}^{2}}{{σ}^{2} {τ}^{2}} {( θ - \frac{{τ}^{2}}{{σ}^{2} + {τ}^{2}} {X}_{j} )}^{2} + \frac{{X}_{j}^{2}}{{σ}^{2} + {τ}^{2}}\end{matrix} \qquad ( 25 )$$

Now use the completed square in (25) to continue the computation in (22).

$$\begin{matrix} f ( {X}_{j} ) = \frac{1}{2 πστ} {\int }_{- ∞}^{∞} {e}^{- \frac{1}{2} \frac{{σ}^{2} + {τ}^{2}}{{σ}^{2} {τ}^{2}} {( θ - \frac{{τ}^{2}}{{σ}^{2} + {τ}^{2}} {X}_{j} )}^{2}} {e}^{- \frac{1}{2} \frac{{X}_{j}^{2}}{{σ}^{2} {τ}^{2}}} d θ \\ = \frac{{e}^{- \frac{{X}_{j}^{2}}{2 ( {σ}^{2} + {τ}^{2} )}}}{2 πστ} {\int }_{- ∞}^{∞} exp [ - {( \text{?} )}^{2} ] d θ\end{matrix} \\ Then \\ \text{?} = d θ / \sqrt{\frac{2 {σ}^{2} {τ}^{2}}{{σ}^{2} + {τ}^{2}}} \\ d θ = \sqrt{\frac{2 {σ}^{2} {τ}^{2}}{{σ}^{2} + {τ}^{2}}} \text{?} \\ θ = \pm ∞ ϕ = \pm ∞ \\ ϕ = ( θ - \frac{{τ}^{2}}{{σ}^{2} + {τ}^{2}} {X}_{j} ) / \sqrt{\frac{2 {σ}^{2} {τ}^{2}}{{σ}^{2} + {τ}^{2}}} \\ and \\ \begin{matrix} f ( {X}_{j} ) = \frac{{e}^{- \frac{{X}_{j}^{2}}{2 ( {σ}^{2} + {τ}^{2} )}}}{2 πστ} {\int }_{- ∞}^{∞} {e}^{- {ϕ}^{2}} \sqrt{\frac{2 {σ}^{2} {τ}^{2}}{{σ}^{2} + {τ}^{2}}} d ϕ \\ = \frac{{e}^{- \frac{{X}_{j}^{2}}{2 ( {σ}^{2} + {τ}^{2} )}}}{π \sqrt{2 ( {σ}^{2} + {τ}^{2} )}} \underbrace{{\int }_{- ∞}^{∞} {e}^{- {ϕ}^{2}} d ϕ}_{\sqrt{π}} \\ = \frac{1}{\sqrt{2 π ( {σ}^{2} + {τ}^{2} )}} {e}^{- \frac{{X}_{j}^{2}}{2 ( {σ}^{2} + {τ}^{2} )}}\end{matrix} \\ Therefore \\ f ( {X}_{j} ) = \frac{1}{\sqrt{2 π ( {σ}^{2} + {τ}^{2} )}} {e}^{- \frac{{X}_{j}^{2}}{2 ( {σ}^{2} + {τ}^{2} )}} \\ \text{?} \text{indicates text missing or illegible when filed} \qquad ( 26 )$$

### A.3 Calculation of The Posterior Distribution of θⱼ

Since the subscript j remains constant throughout the calculation, it will be dropped in this appendix. Herein, θⱼ will be replaced by θ, and X.ⱼ by X.

$$\begin{matrix}π ( θ \vert X ) = \frac{f ( X \vert θ ) π ( θ )}{f ( X )} \\ = \text{?} \text{?} \\ = \text{?} \\ = \frac{1}{\sqrt{2 π \frac{{σ}^{2} {τ}^{2}}{{σ}^{2} + {τ}^{2}}}} exp [ - \frac{1}{2} \underbrace{( \frac{{θ}^{2}}{{τ}^{2}} + \frac{{( X - θ )}^{2}}{{σ}^{2}} - \frac{{X}^{2}}{{σ}^{2} + {τ}^{2}} )} ]\end{matrix} \\ * \begin{matrix}\frac{{θ}^{2}}{{τ}^{2}} + \frac{{( X - θ )}^{2}}{{σ}^{2}} - \frac{{X}^{2}}{{σ}^{2} + {τ}^{2}} = = \frac{1}{{σ}^{2} {τ}^{2} ( {σ}^{2} + {τ}^{2} )} [ {σ}^{2} ( {σ}^{2} + {τ}^{2} ) {θ}^{2} + {τ}^{2} ( {σ}^{2} + {τ}^{2} ) \overbrace{{( X - θ )}^{2}}^{{X}^{2} - 2 X θ + {θ}^{2}} \text{?} {σ}^{2} {τ}^{2} {X}^{2} ] \\ = \frac{1}{{σ}^{2} {τ}^{2} ( {σ}^{2} + {τ}^{2} )} [ {θ}^{2} ( {σ}^{2} ( {σ}^{2} + {τ}^{2} ) + {τ}^{2} ( {σ}^{2} + {τ}^{2} ) ) - 2 {τ}^{2} ( {σ}^{2} + {τ}^{2} ) X θ + \\ {X}^{2} ( {τ}^{2} ( {σ}^{2} + {τ}^{2} ) - {σ}^{2} {τ}^{2} ) ] \\ = \frac{1}{{σ}^{2} {τ}^{2} ( {σ}^{2} + {τ}^{2} )} [ {{θ}^{2} ( \text{?} )}^{2} - 2 ( {σ}^{2} + {τ}^{2} ) θ \cdot {τ}^{2} X + \text{?} {X}^{2} ] \\ = \frac{1}{{σ}^{2} {τ}^{2} ( \text{?} )} {( ( {σ}^{2} + {τ}^{2} ) θ - {τ}^{2} X )}^{2} \\ = \frac{1}{{σ}^{2} {τ}^{2} ( {σ}^{2} + {τ}^{2} )} {( {σ}^{2} + {τ}^{2} )}^{2} {( θ - \frac{{τ}^{2}}{{σ}^{2} + {τ}^{2}} X )}^{2} \\ = {( θ - \frac{{τ}^{2}}{{σ}^{2} + {τ}^{2}} X )}^{2} / \frac{{σ}^{2} {τ}^{2}}{{σ}^{2} + {τ}^{2}}\end{matrix} \\ Therefore , \\ π ( θ \vert X ) = \frac{1}{\sqrt{2 π \frac{{σ}^{2} {τ}^{2}}{{σ}^{2} + {τ}^{2}}}} exp [ - \text{?} ] \\ \text{?} \text{indicates text missing or illegible when filed} \qquad ( 27 )$$

A.4 Proof of the Fact that n Independent Observations from the Normal Population [symbol] (θ, σ²) can be Treated as a Single Observation from [symbol] (θ, σ²/n)
Given the data y, f(y|θ) can be viewed as a function of θ. We then can it the likelihood fuction of θ for given y, and write

l(θ|y)∝f(y|θ).

When y is a single data point from [symbol] (θ, σ²),

$$l ( θ \vert y ) ∝ exp [ - \frac{1}{2} {( \frac{θ - x}{σ} )}^{2} ] = exp [ - \frac{1}{2 {σ}^{2}} {( θ - x )}^{2} ] , \qquad ( 28 )$$

where x is some function of y.

Now, suppose that y̅=(y₁, . . . , yₙ) represents a vector of n independent observations from [symbol] (θ, σ²). We can denote the sample mean by

$$\overline{y} = \frac{1}{n} {\sum }_{i = 1}^{n} {y}_{i} .$$

The likelihood function of θ given such n independent observations from [symbol] (θ, σ²) is

$$l ( θ \vert \overline{y} ) ∝ {\prod }_{i} exp [ - \frac{1}{2 {σ}^{2}} {( {y}_{i} - θ )}^{2} ] = exp ⌊ - \frac{1}{2 {σ}^{2}} {\sum }_{i} {( {y}_{i} - θ )}^{2} ⌋ .$$

Also, since

$${\sum }_{i = 1}^{n} {( {y}_{i} - θ )}^{2} = {\sum }_{i = 1}^{n} {( {y}_{i} - \overline{y} )}^{2} + {n ( \overline{y} - θ )}^{2} , \qquad ( 29 )$$

it follows that

$$l ( θ \vert \overline{y} ) ∝ \underbrace{exp [ - \frac{1}{2 {σ}^{2}} {\sum }_{i} {( {y}_{i} - \overline{y} )}^{2} ]}_{const w . r . t . θ} exp [ - \frac{1}{2 \text{?}} {n ( \overline{y} - θ )}^{2} ] ∝ exp [ - \frac{1}{2 ( {σ}^{2} / n )} {( θ - \overline{y} )}^{2} ] , \\ \text{?} \text{indicates text missing or illegible when filed} \qquad ( 30 )$$

which is a Normal function with mean y̅ and variance σ²/n. Comparing with (28), we can recognize that this is equivalent to treating the data y̅ as a single observation y̅ with mean θ and variance σ²/n, i.e.,

y̅˜ [symbol] (θ,σ²/n). (31)

### Proof of (29)

$$\begin{matrix}{\sum }_{i = 1}^{n} {( {y}_{i} - θ )}^{2} = {\sum }_{i} {( {y}_{i} - \overline{y} + \overline{y} - θ )}^{2} \\ = {\sum }_{i} [ {( {y}_{i} - \overline{y} )}^{2} + 2 ( {y}_{i} - \overline{y} ) ( \overline{y} - θ ) + {( \overline{y} - θ )}^{2} ] \\ = {\sum }_{i} {( {y}_{i} - \overline{y} )}^{2} + 2 ( \overline{y} - θ ) {\sum }_{i} ( {y}_{i} - \overline{y} ) + {\sum }_{i} {( \overline{y} - θ )}^{2} \\ = {\sum }_{i} {( {y}_{i} - \overline{y} )}^{2} + 2 ( \overline{y} - θ ) \underbrace{( {\sum }_{i} {y}_{i} - {\sum }_{i} \overline{y} )}_{n \overline{y} - n \overline{y} = 0} + {n ( \overline{y} - θ )}^{2} \\ = {\sum }_{i} {( {y}_{i} - \overline{y} )}^{2} + {n ( \overline{y} - θ )}^{2}\end{matrix}$$

### A.5 Distribution Of the Sum of Two Independent Normal Random Variables

### Let

X˜ [symbol] (0,α²)

Y˜ [symbol] (0,β²)

be two independent random variables.

Claim: X+Y˜ [symbol] (0,α²αβ²)

(This result is used for mean -0 Normal r.v.'s, although a more general remit can be proven.)
Proof: (use moment generating functions)

$$\begin{matrix}{m}_{X} ( t ) = E ( {e}^{tX} ) = {\int }_{- ∞}^{∞} {e}^{tx} \cdot \frac{1}{\sqrt{2 π} α} {e}^{- \frac{1}{2 {α}^{2}} {( x - 0 )}^{2}} d x \\ = \frac{1}{\sqrt{2 π} α} {\int }_{- ∞}^{∞} {e}^{- \frac{1}{2 {α}^{2}} \underbrace{[ {x}^{2} - 2 {α}^{2} tx ]}} d x\end{matrix} \qquad ( 32 )$$

Completing the square, we obtain

$$\begin{matrix}\begin{matrix}{x}^{2} - 2 {α}^{2} tx = {x}^{2} - 2 ( {α}^{2} t ) x + {( {α}^{2} t )}^{2} - {( {α}^{2} t )}^{2} \\ = {( x - {α}^{2} t )}^{2} - ( {α}^{4} {t}^{2} )\end{matrix} & ( 33 ) \\ \begin{matrix}\frac{1}{{α}^{2}} ( {x}^{2} - 2 {α}^{2} tx ) = {( ( x - {α}^{2} t ) / α )}^{2} - ( {α}^{4} {t}^{2} ) / {α}^{2} \\ = {( \frac{x - {α}^{2} t}{α} )}^{2} - {α}^{2} {t}^{2} .\end{matrix} & \end{matrix}$$

Using the result of (33) in (32) yields

$${m}_{X} ( t ) = \frac{{e}^{- \frac{1}{2} ( - {α}^{2} {t}^{2} )}}{\sqrt{2 π} α} {\int }_{- ∞}^{∞} {e}^{- \frac{1}{2} {( \frac{x - {α}^{2} t}{α} )}^{2}} d x$$

$$Let y = \frac{x - {α}^{2} t}{α}$$

$$dy = \frac{dx}{α} dx = α dy$$

With this substitution, we obtain

$$\begin{matrix}{m}_{X} ( t ) = \frac{{e}^{\frac{1}{2} {α}^{2} {t}^{2}}}{\sqrt{2 π} α} \cdot α \underbrace{{\int }_{y = - α}^{∞} {e}^{- \frac{1}{2} {y}^{2}} d y}_{\sqrt{2 π}} \\ or \\ {m}_{X} ( t ) = {e}^{\frac{1}{2} {α}^{2} {t}^{2}} \\ Similarly & ( 34 ) \\ {m}_{Y} ( t ) = {e}^{\frac{1}{2} {β}^{2} {t}^{2}} & ( 35 )\end{matrix}$$

To obtain the distribution of X′Y, it suffices to compute the corresponding moment generating function:

$$\begin{matrix}{m}_{X + Y} ( t ) = E ( {e}^{t ( X + Y )} ) \\ = E ( {e}^{tX} {e}^{tY} ) \\ = E ( {e}^{tX} ) E ( {e}^{tY} ) by the independence of X and Y \\ = {m}_{X} ( t ) \cdot {m}_{Y} ( t ) \\ = {e}^{\frac{1}{2} {α}^{2} {t}^{2}} \cdot {e}^{\frac{1}{2} {β}^{2} {t}^{2}} by ( 34 ) and ( 35 ) \\ = {e}^{\frac{1}{2} ( {α}^{2} + {β}^{2} ) {t}^{2}} ,\end{matrix}$$

which is a moment generating function of a Normal random variable with mean 0 and variance α²+β². Therefore,

X+Y˜ [symbol] (0,α²+β²). (36)

### A.6 Properties of the Chi-Square Distrribution

Let X₁, X₂, . . . , Xₖ be i.i.d.r.v's from standard Normal distribution, i.e.,

$${X}_{j} \sim 𝒩 ( 0 , 1 ) ∀ j , \\ Then$$

$${χ}_{k}^{2} = {X}_{1}^{2} + {X}_{2}^{2} + … + {X}_{k}^{2} = {\sum }_{j = 1}^{k} {X}_{j}^{2}$$

is a random variable from Chi-square distribution with k degrees of freedom, denoted

χₖ²˜χ₍ₖ₎².

It has the probability density function

$$f ( x ) = \{ \begin{matrix}\frac{1}{{2}^{k / 2} Γ ( k / 2 )} {x}^{k / 2 - 1} {e}^{- x / 2} & for x > 0 \\ 0 & otherwise\end{matrix} \\ where \\ Γ ( k ) = {\int }_{0}^{∞} {t}^{k - 1} {e}^{- t} d t . \qquad ( 37 )$$

The result we are using is

$$E ( \frac{1}{{χ}_{k}^{2}} ) = \frac{1}{k - 2} for k > 2 ,$$

which can be obtained as follows:

$$\begin{matrix}\begin{matrix}E ( \frac{1}{{χ}_{k}^{2}} ) = {\int }_{\text{?}} \frac{1}{x} f ( x ) d x \\ = \frac{1}{{2}^{k / 2} Γ ( k / 2 )} {\int }_{0}^{∞} \frac{1}{x} {x}^{k / 2 - 1} {e}^{- x / 2} d x \\ = \frac{1}{{2}^{k / 2} Γ ( k / 2 )} {\int }_{0}^{∞} {x}^{k / 2 - 2} {e}^{- x / 2} d x\end{matrix} & ( 38 ) \\ Let \\ t = x / 2 x = 2 t \\ dx = 2 dt \\ x = 0 t = 0 \\ x = ∞ t = ∞ \\ \begin{matrix}{\int }_{0}^{∞} {x}^{k / 2 - 2} {e}^{- x / 2} d x = {\int }_{t = 0}^{∞} {( 2 t )}^{k / 2 - 2} {e}^{- t} 2 d t \\ = {2}^{k / 2 - 2} \cdot 2 {\int }_{0}^{∞} {t}^{k / 2 - 2} {e}^{- t} d t .\end{matrix} & ( 39 ) \\ Let \\ u = {e}^{- t} \\ dv = {t}^{k / 2 - 2} dt \\ du = - {e}^{- t} dt \\ v = \frac{{t}^{k / 2 - 1}}{k / 2 - 1} for k > 2 \\ \text{?} \text{indicates text missing or illegible when filed} & \end{matrix}$$

Integration by parts transforms (39) into

$$\begin{matrix}= {2}^{k / 2 - 1} ( \frac{1}{k / 2 - 1} \underbrace{{e}^{- t} \text{?} {\vert}_{0}^{∞}}_{\text{?}} - {\int }_{0}^{∞} \frac{1}{k / 2 - 1} {t}^{k / 2 - 1} ( - {e}^{- t} ) d t ) \\ = \frac{{2}^{k / 2 - 1}}{k / 2 - 1} \underbrace{{\int }_{0}^{∞} {t}^{k / 2 - 1} {e}^{- t} d t}_{Γ ( k / 2 ) , by ( 37 )} \\ = \frac{{2}^{k / 2 - 1}}{k / 2 - 1} Γ ( k / 2 )\end{matrix}$$

$$\text{?} \text{indicates text missing or illegible when filed}$$

Substituting this result in (38) yields

$$\begin{matrix}E ( \frac{1}{{χ}_{k}^{2}} ) = \frac{1}{{2}^{k / 2} Γ ( k / 2 )} \cdot \frac{{2}^{k / 2 - 1} Γ ( k / 2 )}{k / 2 - 1} \\ = \frac{1}{2 ( k / 2 - 1 )} \\ = \frac{1}{k - 2} for k > 2.\end{matrix} \qquad ( 40 )$$

### A.7 Distribution of Sample Variance S²

Let, Xⱼ˜ [symbol] (μ, σ²) for j=1, . . . , n be independent r.v.'s. We'll derive the joint distribution of

$$\frac{\sqrt{n} ( \overline{X} - μ )}{σ} and \frac{( n - 1 ) {s}^{2}}{{σ}^{2}} . \\ {s}^{2} = \frac{1}{n - 1} {\sum }_{j = 1}^{n} {( {X}_{j} - \overline{X} )}^{2}$$

$$\begin{matrix}\frac{( n - 1 ) {s}^{2}}{{σ}^{2}} = \frac{n - 1}{{σ}^{2}} \cdot \frac{1}{n - 1} {\sum }_{j = 1}^{n} {( {X}_{j} - \overline{X} )}^{2} \\ = {\sum }_{j = 1}^{n} {( \frac{{X}_{j} - \overline{X}}{σ} )}^{2}\end{matrix}$$

W.L.O.G. can reduce the problem to the case [symbol] (0,1), i.e., μ=0, σ²=1: Let Zⱼ=(Xⱼ=μ)/σ. Then

$$\begin{matrix}\begin{matrix}\overline{Z} = \frac{1}{n} \sum {Z}_{j} \\ = \frac{1}{n} \sum ( \frac{{X}_{j} - μ}{σ} ) \\ = \frac{1}{n} ( \frac{\sum {X}_{j}}{σ} - \frac{\sum μ}{σ} ) \\ = \frac{1}{n} ( \frac{\sum {X}_{j}}{σ} - \frac{n μ}{σ} ) \\ = \frac{1}{σ} ( \frac{\sum {X}_{j}}{n} - μ ) \\ = \frac{\overline{X} - μ}{σ}\end{matrix} \\ and hence \\ \frac{\sqrt{n} ( \overline{X} - μ )}{σ} = \sqrt{n} \overline{Z} . \\ Also , & ( 41 ) \\ \begin{matrix}\frac{( n - 1 ) {s}^{2}}{{σ}^{2}} = \frac{1}{{σ}^{2}} \sum {( {X}_{j} - \overline{X} )}^{2} \\ = \frac{1}{{σ}^{2}} \sum {( ( {X}_{j} - μ ) + ( μ - \overline{X} ) )}^{2} \\ = \sum {[ \frac{{X}_{j} - μ}{σ} - \frac{\overline{X} - μ}{σ} ]}^{2} = \sum {( {Z}_{j} - \overline{Z} )}^{2}\end{matrix} & ( 42 )\end{matrix}$$

By (41) and (42), it suffices to derive the joint distribution of \sqrt{n} Z̅ and Σⱼ₌₁ⁿ (Zⱼ− Z̅)², where Z₁, . . . , Zₙ i.i.d. from [symbol] (0,1),

Let

$$P = ( \begin{matrix}{— p}_{1} — \\ {— p}_{2} — \\ ⋮ \\ {— p}_{n} —\end{matrix} )$$

be an n×n orthogonal matrix where

$${p}_{1} = ( \frac{1}{\sqrt{n}} , … , \frac{1}{\sqrt{n}} )$$

and the remaining rows pⱼ are obtained by, say, applying Gramm-Schmidt to {p₁, e₂, e₃, . . . , eₙ}, where eⱼ is a standard unit vector in j^{th} direction in [symbol] ⁿ. Let

$$\vec{Y} = P \vec{Z} = ( \begin{matrix}\begin{matrix}\frac{1}{\sqrt{n}} & \frac{1}{\sqrt{n}} & … & \frac{1}{\sqrt{n}}\end{matrix} \\ \_\_\_ \_\_\_ \_\_\_ \_\_\_ \_\_\_ \_\_ \\ ⋮ \\ \_\_\_ \_\_\_ \_\_\_ \_\_\_ \_\_\_ \_\_\end{matrix} ) ( \begin{matrix}{Z}_{1} \\ {Z}_{2} \\ ⋮ \\ {Z}_{n}\end{matrix} ) = ( \begin{matrix}{Y}_{1} \\ {Y}_{2} \\ ⋮ \\ {Y}_{n}\end{matrix} ) \\ Then \\ {Y}_{1} = \frac{1}{\sqrt{n}} ( {\sum }_{j = 1}^{n} {Z}_{j} ) = \frac{1}{\sqrt{n}} n \overline{Z} = \sqrt{n} \overline{Z} . \qquad ( 43 )$$

Since P is orthogonal, it preserves vector lengths:

$$\begin{matrix}{‖ \vec{Y} ‖}^{2} = {‖ \vec{Z} ‖}^{2} \\ {\sum }_{j = 1}^{n} {Y}_{j}^{2} = {\sum }_{j = 1}^{n} {Z}_{j}^{2} \\ ⇒ ( {\sum }_{j = 1}^{n} {Y}_{j}^{2} ) - {Y}_{1}^{2} = {\sum }_{j = 1}^{n} {Z}_{j}^{2} - {( \sqrt{n} \overline{Z} )}^{2} \\ by Hence & ( 43 ) \\ \begin{matrix}{\sum }_{j = 2}^{n} {Y}_{j}^{2} = {\sum }_{j = 1}^{n} {Z}_{j}^{2} - n {\overline{Z}}^{2} \\ = {\sum }_{j = 1}^{n} {Z}_{j}^{2} - 2 n {\overline{Z}}^{2} + n {\overline{Z}}^{2} \\ = {\sum }_{j = 1}^{n} {Z}_{j}^{2} - 2 \overline{Z} ( n \overline{Z} ) + n {\overline{Z}}^{2} \\ = {\sum }_{j = 1}^{n} {Z}_{j}^{2} - 2 \overline{Z} ( {\sum }_{j = 1}^{n} {Z}_{j} ) + {\sum }_{j = 1}^{n} {\overline{Z}}^{2} \\ = {\sum }_{j = 1}^{n} {( {Z}_{j} - \overline{Z} )}^{2}\end{matrix} & ( 44 )\end{matrix}$$

Since the Yⱼ's are mutually independent (by orthogonality of P), we can conclude that

$${\sum }_{j = 2}^{n} {Y}_{j}^{2} = {\sum }_{j = 1}^{n} {( {Z}_{j} - \overline{Z} )}^{2}$$

is independent of

Y₁=\sqrt{n} Z̅,

Also by orthogonality of P, Y₃˜ [symbol] (0,1) for j=1, . . . , n, so

$$( {\sum }_{j = 2}^{n} {Y}_{j}^{2} ) ∼ {χ}_{( n - 1 )}^{2} \\ ( See Appendix A .6 )$$

and hence, by (42) and (44),

$$\frac{( n - 1 ) {s}^{2}}{{σ}^{2}} ∼ {χ}_{( n - 1 )}^{2} \qquad ( 45 )$$

Since E (χₖ²)=k, for χ_{Io}²˜χ₍ₖ₎², we can see that

$$E ( \frac{( n - 1 ) {s}^{2}}{{σ}^{2}} ) = n - 1.$$

Also, since

$$E ( \frac{( n - 1 ) {s}^{2}}{{σ}^{2}} ) = \frac{n - 1}{{σ}^{2}} E ( {s}^{2} ) ,$$

we can conclude that

$$E ( {s}^{2} ) = \frac{{σ}^{2}}{n - 1} , \frac{n - 1}{{σ}^{2}} E ( {s}^{2} ) = \frac{{σ}^{2}}{n - 1} \cdot ( n - 1 ) = {σ}^{2} , \qquad ( 46 )$$

i.e., s² is an unbiased estimator of the variance σ².

Various publications have been referenced herein, the contents of which are hereby incorporated by reference in their entireties. It should be noted that all procedures and algorithms according to the present invention described herein can be performed using the exemplary systems of the present invention illustrated in FIGS. 1 and 2 and described herein, as well as being programmed as software arrangements according to the present invention to be executed by such systems or other exemplary systems and/or processing arrangements.

1. A method for determining an association between a first dataset and a second dataset comprising:
a) obtaining at least one first data corresponding to one or more prior assumptions regarding said first and second datasets;
b) obtaining at least one second data corresponding to one or more portions of actual information regarding said first and second datasets; and
c) using a hardware processing arrangement, combining the at least one first data and the at least one second data to determine the association between the first and second datasets.

2-24. (canceled)

25. A non-transitory computer-readable medium for determining an association between a first dataset and a second dataset, including instructions thereon that are accessible by a hardware processing arrangement, wherein, when the processing, arrangement executes the instructions, the processing arrangement is configured to perform procedures comprising:
a) obtaining at least one first data corresponding to one or more prior assumptions regarding said first and second datasets;
b) obtaining at least one second data corresponding to one or more portions of actual information regarding said first and second datasets; and
c) combining the at least one first data and the at least one second data to determine the association between the first and second datasets.

26. The computer-readable medium of claim 25, wherein one of the one or more prior assumptions is that the means of the first and second datasets are random variables with a known a priori distribution.

27. The computer-readable medium of claim 25, wherein one of the one or more prior assumptions is that the means of the first and second datasets are normal random variables with an a priori Gaussian distribution N(μ, τ²), where parameters μ, the mean, and τ, the variance, may be unknown.

28. The computer-readable medium of claim 25, wherein one of the one or more prior assumptions is that the means of the first and second datasets are normal random variables with an a priori Gaussian distribution N(μ, τ²), where parameter μ is known.

29. The computer-readable medium of claim 25, wherein one of the one or more prior assumptions is that the means of the first and second datasets are zero-mean normal random variables with an a priori Gaussian distribution N(μ, τ²), wherein μ=0.

30. The computer-readable medium of claim 25, wherein one of the one or more portions of the actual information is an a posteriori distribution of the means of the first and second datasets obtained directly from the first and second datasets.

31. The computer-readable medium of claim 25, wherein the association is a correlation.

32. The computer-readable medium of claim 25, wherein the association is a dot product.

33. The computer-readable medium of claim 25, wherein the association is a Euclidean distance.

34. The computer-readable medium of claim 31, wherein the determination of the correlation comprises a use of James-Stein Shrinkage estimators in conjunction with the first and second data.

35. The computer-readable medium of claim 34, wherein the determination of the correlation utilizes a correlation coefficient that is modified by an optimal shrinkage parameter γ.

36. The computer-readable medium of claim 35, wherein determination of the optimal shrinkage parameter γ comprises the use of Bayesian considerations in conjunction with the first and second data.

37. The computer-readable medium of claim 35, wherein the shrinkage parameter γ is estimated from the datasets using cross-validation.

38. The computer-readable medium of claim 35, wherein the shrinkage parameter γ is estimated by simulation.

39. The computer-readable medium of claim 35, wherein the correlation coefficient includes a plurality of correlation coefficients parameterized by 0≦γ≦1 and may be defined, for datasets Xⱼ and Xₖ as:
wherein
$$S ( {X}_{j} , {X}_{k} ) = \frac{1}{N} {\sum }_{i = 1}^{N} ( \frac{{X}_{ij} - {( {X}_{j} )}_{offset}}{{Φ}_{j}} ) ( \frac{{X}_{ik} - {( {X}_{k} )}_{offset}}{{Φ}_{k}} ) , \\ {Φ}_{j}^{2} = \frac{1}{N} {\sum }_{i} {( {X}_{ij} - {( {X}_{j} )}_{offset} )}^{2}$$

40. The computer-readable medium of claim 39, wherein γ
$$= \underbrace{( 1 - \frac{M - 2}{MN ( N - 1 )} \cdot \frac{{\sum }_{k = 1}^{M} {\sum }_{i = 1}^{N} {( {X}_{ik} - {Y}_{k} )}^{2}}{{\sum }_{k = 1}^{M} {Y}_{k}^{2}} )}_{γ} {Y}_{j}$$
where M represents, in an M×N matrix, a number of rows corresponding to datapoints from the first dataset, and N represents a number of columns corresponding to datapoints from the second dataset.

41. The computer-readable medium of claim 40, wherein M is the number of rows corresponding to all genes from which expression data has been collected in one or more microarray experiments.

42. The computer-readable medium of claim 40, wherein M is representative of a genotype and N is representative of a phenotype.

43. The computer-readable medium of claim 42, wherein the correlation is a genotype/phenotype correlation.

44. The computer-readable medium of claim 43, wherein the genotype/phenotype correlation is indicative of a causal relationship between a genotype and a phenotype.

45. The computer-readable medium of claim 44, wherein the phenotype is that of a complex genetic disorder.

46. The computer-readable medium of claim 45, wherein the complex genetic disorder includes at least one of a cancer, a neurological disease, a developmental disorder, a neurodevelopmental disorder, a cardiovascular disease, a metabolic disease, an immunologic disorder, an infectious disease, and an endocrine disorder.

47. The computer-readable medium of claim 31 wherein the correlation is provided between financial information for one or more financial instruments traded on a financial exchange.

48. The computer-readable medium of claim 31 wherein the correlation is provided between user profiles for one or more users in an e-commerce application.

49-72. (canceled)

73. A system for determining an association between a first dataset and a second dataset comprising a hardware processing arrangement configured to perform procedures comprising:
a) obtaining at least one first data corresponding to one or more prior assumptions regarding said first and second datasets;
b) obtaining at least one second data corresponding to one or more portions of actual information regarding said first and second datasets; and
c) with, the processing arrangement, combining the at least one first data and the at least one second data to determine the association between the first and second datasets.

74-96. (canceled)
